(19) United States
(12) Patent Application Publication
(10) Pub. No.: US 2021/0199540 A1
(43) Pub. Date: Jul. 1, 2021

(54) Effort Fixture for Gauge Repeatability and Reproducibility

(71) Applicant: Lear Corporation, Southfield, MI (US)

(72) Inventors: John Fazecas, Southfield, MI (US); Kevin Jordan, Southfield, MI (US)

(73) Assignee: Lear Corporation, Southfield, MI (US)

(21) Appl. No.: 16/729,946

(22) Filed: Dec. 30, 2019

(51) Int. Cl. G01M 99/00

(52) U.S. Cl. CPC G01M 99/001; B60N 2/20

(57) ABSTRACT

A fixture for testing efforts is described. The fixture may include a carriage, a platform mounted on the carriage, and a plurality of receiving members located at testing module positions around or in the platform. The platform is configured to receive one or more vehicle seats to be efforts tested. The fixture may further include a tumble return assembly, a lever test module, a headrest button test assembly, a slide assembly, a strap pull assembly, an anti-tilt tooling assembly, a calibration module, a seat back lift assembly, a headrest lift assembly, a weight box, and a tumble stop.

### BACKGROUND

Vehicle seat assemblies have a variety of movably interconnected components formed and/or made from a relatively wide variety of materials. A seat assembly for a motor vehicle may include a seat cushion and a seat back coupled to the seat cushion, where the seat cushion can be fixedly attached to the floor of the motor vehicle. Certain components of a seat assembly require a certain predetermined force, or effort, for moving and adjusting the component. The seat components also include a predetermined range of movement, or travel, for adjusting the component and accommodating various seat occupants. Therefore, it is important to measure the amount of effort (i.e., force or energy) required to operate the various components as well as the length, or distance, of travel defining the range of adjustment of the various components of a seat assembly. Such efforts and travels may be measured manually, typically with a hand-held gauge, and individually for each component of the seat assembly. However, this can be very subjective and inefficient.

There is a need in the art for new and improved fixtures and methods for performing effort checks.

### SUMMARY

Provided is a fixture comprising a carriage and a platform mounted on the carriage, wherein the platform is configured to receive one or more seat assemblies and the carriage comprises an assembly of members forming a base; and a plurality of receiving members located at testing module positions around or in the platform, wherein each of the plurality of receiving members defines an opening and is either fixedly attached to the carriage at a distance away from the carriage or defines a platform opening.

Further provided is a method for effort testing vehicle seat assemblies, the method comprising attaching a first seat assembly and a second seat assembly to a fixture, wherein the fixture comprises a carriage, a platform mounted on the carriage, and a plurality of receiving members located around or in the platform, wherein the receiving members are configured to receive testing modules; conducting a first sequence of tests on the first seat assembly and the second seat assembly with testing modules in the receiving members, wherein the first sequence of tests comprises track lever tests, fold lever tests, tilt strap tests, tumble lever tests, and tumble strap tests; and conducting a second sequence of tests on the first seat assembly and the second seat assembly with testing modules in the receiving members, wherein the second sequence of tests comprises armrest tests, track effort tests, headrest button tests, headrest tilt tests, seat back folding tests, tumble efforts tests, and seat clip weight tests.

### BRIEF DESCRIPTION OF THE DRAWINGS

The patent or application file may contain one or more drawings executed in color and/or one or more photographs. Copies of this patent or patent application publication with color drawing(s) and/or photograph(s) will be provided by the U.S. Patent and Trademark Office upon request and payment of the necessary fees.

FIG. 1: Perspective view of an embodiment of a fixture in accordance with the present disclosure.

FIG. 2: Top-down view of an embodiment of a fixture in accordance with the present disclosure.

FIG. 3: Side perspective view of an embodiment of a fixture in accordance with the present disclosure.

FIG. 4: Illustration depicting testing module positions and slide positions around the a LH seat assembly and a RH seat assembly disposed on a fixture in accordance with the present disclosure. The testing module positions are located around or in the platform.

FIGS. 5A-5G: View of a left-hand (LH) lever test module connected to a fixture at testing module position P1 (FIG. 5A), view of a LH lever test module in isolation (FIG. 5B), view of a LH lever test module connected to the fixture at testing module position P1 with a seat assembly on the fixture (FIG. 5C), views of a LH lever test module with an arm and long stop being used to perform a track lever test showing a track lever of a seat assembly unactuated (FIG. 5D) and actuated (FIG. 5E), and views of a LH lever test module with an arm being used to perform a fold lever test showing a fold lever of a seat assembly unactuated (FIG. 5F) and actuated (FIG. 5G).

FIGS. 6A-6C: Views of a right-hand (RH) lever test module connected to a fixture at testing module position P7 with (FIG. 6A) and without (FIG. 6B) a seat assembly present on the fixture. FIG. 6C shows the RH lever test module with an arm connected to perform a tumble test.

FIGS. 7A-7B: Views of the rear side of a fixture showing the RH lever test module attached at testing module position P7, with the seat assemblies in an upright (FIG. 7A) and folded (FIG. 7B) position.

FIGS. 8A-8G: Views of a headrest button test assembly shown as a LH headrest button test assembly (FIG. 8A), in isolation (FIG. 8B), and as a RH headrest button test assembly (FIG. 8C). FIG. 8D shows a headrest button test assembly, without an optional headrest support. FIGS. 8E-8G show the headrest button assembly in position to test the headrest button on the LH seat assembly (FIG. 8E) and headrest button on the RH seat assembly (FIGS. 8F-8G).

FIGS. 9A-9E: Side perspective view (FIG. 9A) and rear view (FIG. 9B) of a LH strap pull assembly connected to a fixture in accordance with the present disclosure. FIG. 9C shows a LH strap pull assembly in isolation. FIG. 9D shows a side view of the LH strap pull assembly with the arm attached to the seat assembly by the strap of the LH seat assembly. FIG. 9E shows a side view of the LH strap pull assembly with the arm attached to the seat assembly by the strap of the LH seat assembly where the strap is being pulled.

FIGS. 10A-10E: Perspective view of a RH strap pull assembly connected to a fixture in accordance with the present disclosure (FIG. 10A), view of a RH strap pull assembly in isolation (FIG. 10B), side view of the RH strap pull assembly connected to the fixture without (FIG. 10C) and with (FIG. 10D) the strap being pulled, and rear view of the RH strap pull assembly connected to the fixture (FIG. 10E).

FIGS. 11A-11D: Views of an anti-tilt tooling assembly connected to a fixture in accordance with the present disclosure. FIG. 11A shows an elevational view of the anti-tilt tooling assembly. FIG. 11B shows a zoomed-in view of the attachment of the anti-tilt tooling assembly at the testing module position P4. FIG. 11C shows a rear view of the anti-tilt tooling assembly in place when two seat assemblies are connected to the fixture. FIG. 11D shows seat assemblies tilted forward to the stoppers of the anti-tilt tooling assembly.

FIGS. 12A-12B: Views of an armrest bench seat test assembly connected to a fixture in accordance with the present disclosure (FIG. 12A), and an armrest bench seat test assembly in isolation (FIG. 12B).

FIGS. 13A-13G: Views of a captain armrest test assembly connected to a fixture in accordance with the present disclosure in a LH mode (FIG. 13A) and a RH mode (FIG. 13B), in isolation (FIG. 13C), and being used to conduct a LH armrest test (FIGS. 13D-13G).

FIGS. 14A-14B: Views of a calibration module connected to a fixture in accordance with the present disclosure (FIG. 14A), and a calibration module in isolation (FIG. 14B).

FIGS. 15A-15E: Views of a seat back lift assembly in a LH configuration in isolation (FIG. 15A), in a RH configuration in isolation (FIG. 15B), connected to a seat assembly in a folded position (FIG. 15C), connected to a seat assembly in a partially folded position (FIG. 15D), and connected to a seat assembly in an upright position (FIG. 15E).

FIGS. 16A-16F: Views of a headrest lift assembly in isolation (FIG. 16A), connected in a LH position to a fixture in accordance with the present disclosure (FIG. 16B), and connected in a RH position to a fixture in accordance with the present disclosure (FIG. 16C). FIGS. 16D-16F show the headrest lift assembly being used to perform a headrest tilt test on a LH seat assembly headrest.

FIGS. 17A-17B: Views of a tumble return assembly in a first (or down) position (FIG. 17A) and in a second (or up) position (FIG. 17B).

FIGS. 18A-18E: Views of a slide member mounted on a rearward track without (FIG. 18A) and with (FIGS. 18B-18D) seat assemblies on the fixture, and of the slide member in isolation (FIG. 18E). FIG. 18B depicts the slide member at the slide position S1 in front of the RH seat assembly, and FIGS. 18C-18D depict the slide member at the slide position S2 in front of the LH seat assembly. FIG. 18D depicts the slide member performing a track test.

FIGS. 19A-19D: Views of a weight box and weights in accordance with the present disclosure. FIG. 19A shows the weight box open, FIG. 19B shows the weight box closed, FIG. 19C shows the weight box on a folded LH seat assembly, and FIG. 19D shows the weight box on a folded RH seat assembly.

FIG. 20: View showing a lever arm torqueing a handle on a LH lever test module with a force gauge installed to measure the effort involved.

FIGS. 21A-21B: Non-limiting example method of using a fixture in accordance with the present disclosure to check the efforts of two seat assemblies. FIG. 21A illustrates an example first sequence, and FIG. 21B illustrates an example second sequence of the non-limiting example method.

FIG. 22: View of a tumble stop at testing module position P7 of a fixture in accordance with the present disclosure.

FIG. 23: View of an efforts gauge mounted on a tumble return assembly.

FIG. 24: View of a seat assembly being tumbled on a fixture in accordance with the present disclosure.

FIG. 25: View of a seat assembly undergoing a tumble return test on a fixture in accordance with the present disclosure.

### DETAILED DESCRIPTION

Throughout this disclosure, various publications, patents, and published patent specifications may be referenced by an identifying citation. The disclosures of these publications, patents, and published patent specifications are hereby incorporated by reference into the present disclosure in their entirety to more fully describe the state of the art to which this invention pertains.

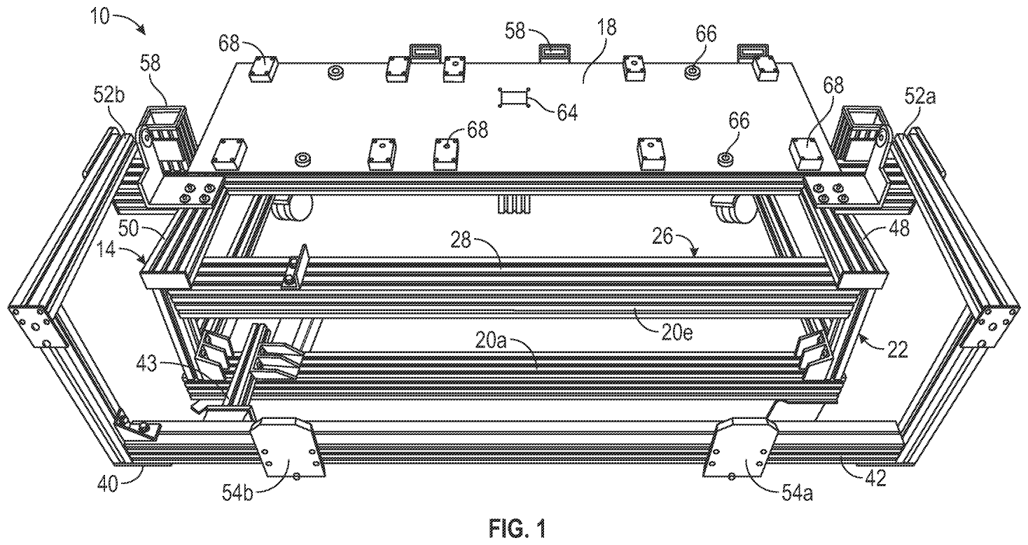

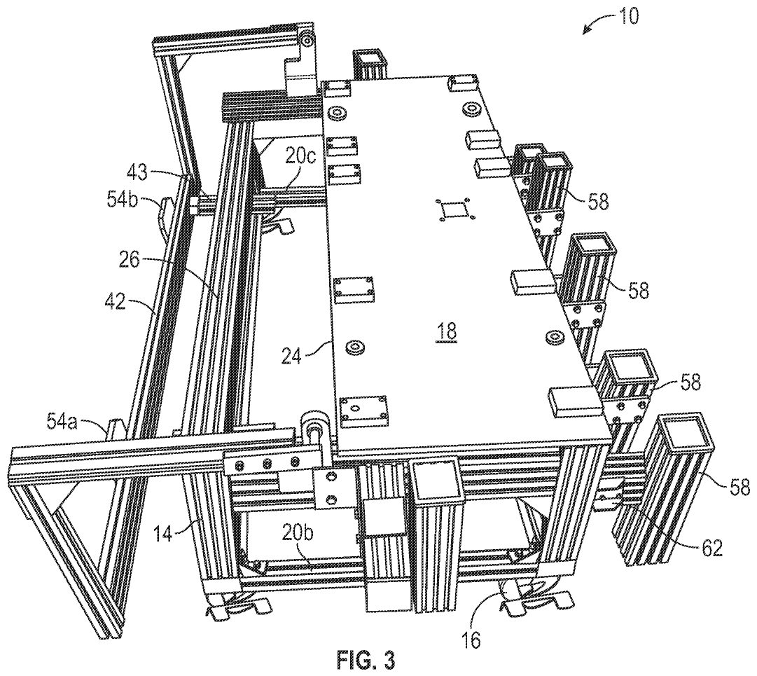

Provided is a fixture useful as a checking fixture for measuring the efforts of the components of one or more seat assemblies, such as motor vehicle seat assemblies. Referring now to FIGS. 1-3, an example embodiment of a fixture 10 is shown without seat assemblies 12. The fixture 10 may include a carriage 14 mounted on wheels 16 with a platform 18 disposed on the carriage 14. The carriage 14 may be formed from a rectangular formation of connected members 20a, 20b, 20c, 20d forming a base 22, with wheels 16 at the corners of the base 22. The carriage 14 may include a rectangular base 22 formed from connected opposing longitudinal members 20a, 20b and opposing latitudinal members 20c, 20d. As seen in FIG. 1, the front side 36 of the fixture 10 may include a first front longitudinal member 20a and a second front longitudinal member 20e where the first longitudinal member 20a is at a bottom of the carriage 14, near where the wheels 16 are connected, and the second front longitudinal member 20e is above the first front longitudinal member 20a relative to the wheels 16. The first front longitudinal member 20a and the second front longitudinal member 20e are disposed at a distance away from the platform 18, and may be parallel to the front edge 24 of the platform 18. In some embodiments, the connecting members 20 of the carriage 14, as well as the outer rail 42, may include grooves 70 on surfaces thereof.

The fixture 10 may further include a rearward track 26 configured to allow sliding movement of a sliding test module, such as between a first sliding test position S1 that may be aligned with a LH seat assembly 12a disposed on the platform to a second sliding test position S2 that may be aligned with a RH seat assembly 12b disposed on the platform 18.

The carriage 14 may include a rearward track 26 defined by a top surface 28 of the second front longitudinal member 20e. The rearward track 26 is configured to receive a testing module that may slide along the rearward track 26 from the left hand (LH) side 30 of the fixture 10 to the right hand (RH) side 32 of the fixture 10. The rearward track 26 may allow sliding movement of a sliding test module, such as between sliding test position S1 and sliding test position S2 that may be aligned with a RH seat assembly 12b and a LH seat assembly 12a disposed on the platform 18, respectively. The rearward track 26 is referred to as rearward despite being located at the front side 36 of the fixture 10 (from the vantage point of seat assemblies 12 disposed on the fixture 10) because the rearward track 26 is configured to allow for efforts testing with a gauge facing in the rearward direction (i.e., toward the rear side 34 of the fixture 10) so as to be facing seat assemblies 12a, 12b mounted on the platform 18.

The wheels 16 may include stoppers 38 to lock movement of the fixture 10. In alternative embodiments, the wheels 16 may be replaced by feet that do not allow for easy movement of the fixture 10.

The fixture 10 may be used to measure of effort of components of a seat assembly 12, or of multiple seat assemblies 12a, 12b. The fixture 10, using various testing module attachments as described in more detail below, may provide forces on or to various components of seat assemblies 12 mounted on the platform 18 that allow for various efforts to be measured. The fixture 10 may include a number of attachments or testing modules for conducting such effort checks on seat assemblies 12. Each effort may have its own testing module that may be readily connected to, or removed from, the fixture 10 as desired or needed. Each effort has its own specifications to measure, and force and torque sensor gauges covering these ranges are used. If higher efforts are to be measured, then different force or torque gauges can be provided. The fixture 10 is thus customizable and adaptable for testing of any particular seat assemblies 12.

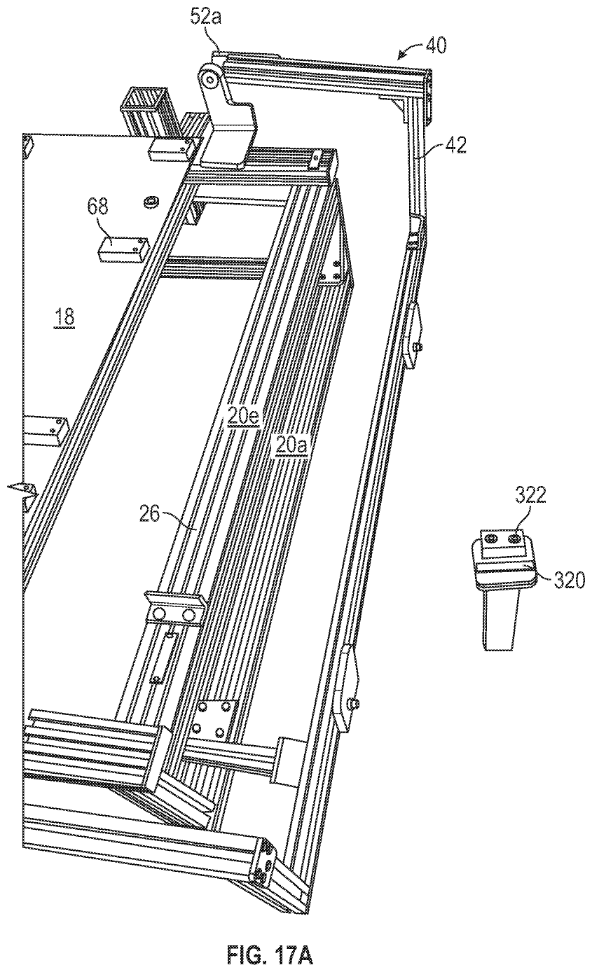

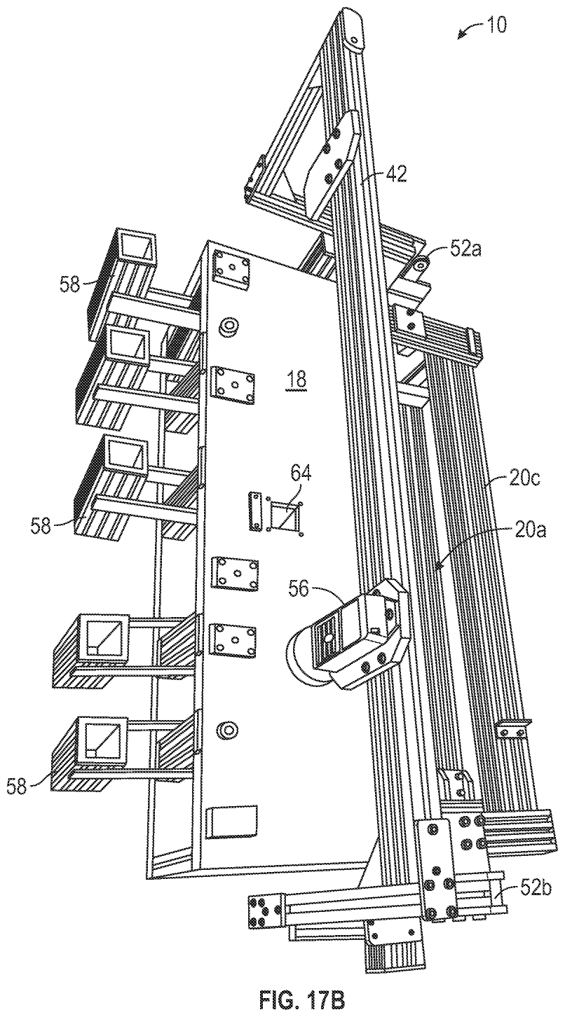

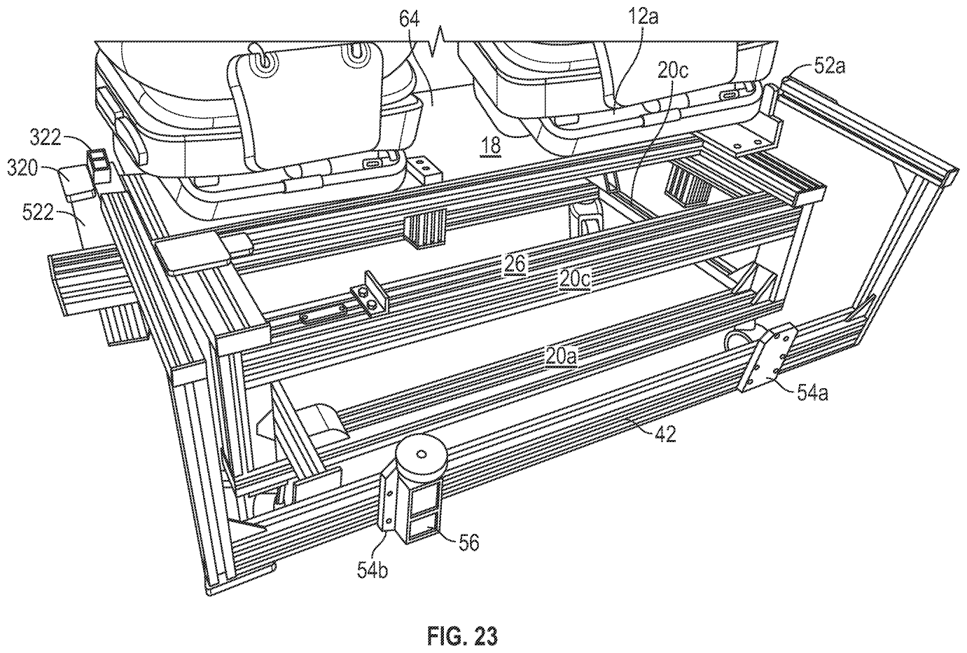

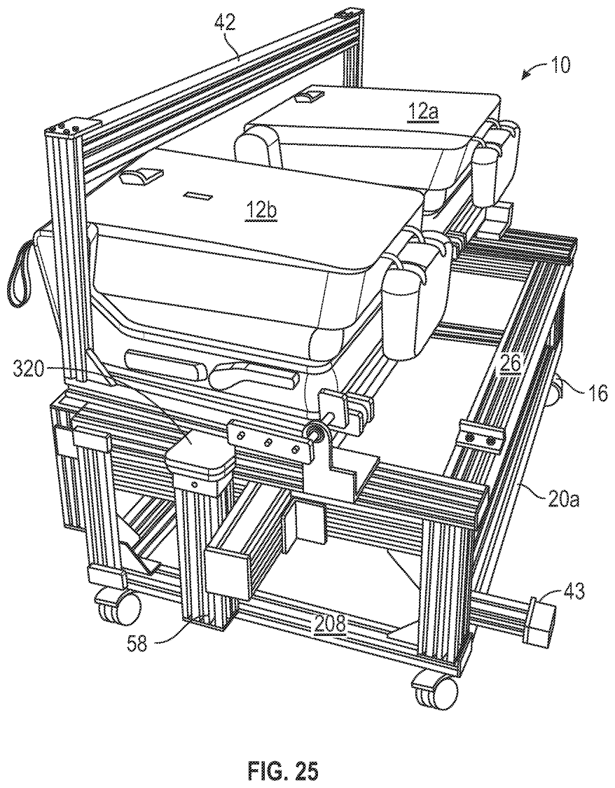

Referring now to FIGS. 1-3, 17, and 22-25, the fixture 10 may include a tumble return assembly 40 having an outer rail assembly 42 extending between positions outwardly displaced from the first side edge 48 of the carriage 14 and the second side edge 50 of the carriage 14. The tumble return assembly 40, which may be used to test rotational motion of a seat assembly 12 as described in more detail below, includes the outer rail assembly 42 being pivotably attached to the carriage 14 through joints 52a, 52b. The tumble return assembly 40 may include one or more mounting brackets 54a, 54b for mounting a test gauge 56 or other equipment on the outer rail assembly 42, as seen for example in FIG. 23. Given the pivotable attachment, the outer rail assembly 42 may be moved from a down position, as seen in FIGS. 1-3, where the outer rail assembly 42 is disposed below the platform 18 and a distance away from the front first and second longitudinal members 20a, 20e, to an up position, as seen in FIGS. 17B, 25, where the outer rail 42 is disposed above the platform 18. The purpose of this pivoting will be explained in more detail below. A tumble return stop 43 may extend an adjustable distance from the first front longitudinal member 20a to act to stop, or hold in place, the outer rail assembly 42 in the down position.

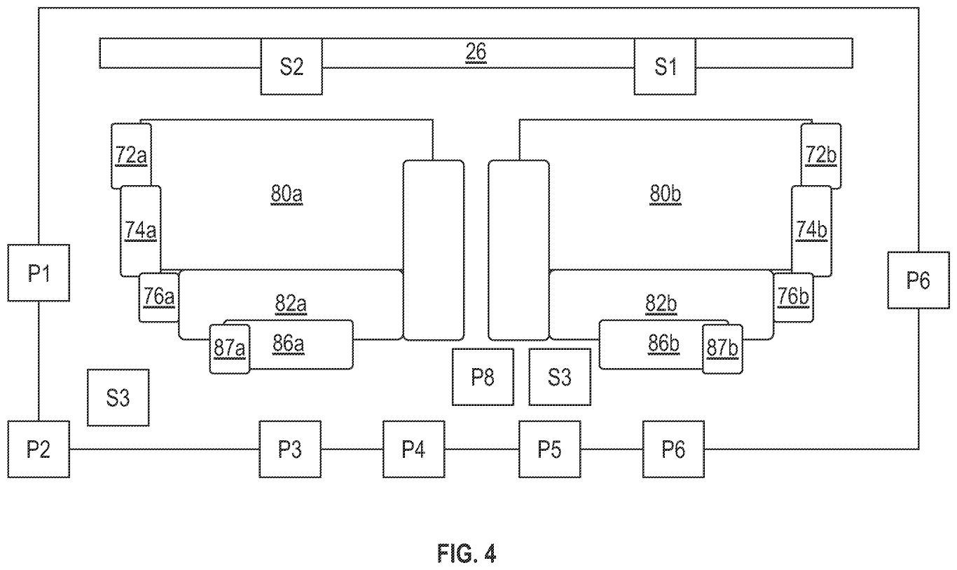

Referring still to FIGS. 1-4, the fixture 10 may include a plurality of receiving members 58 at locations referring to as testing module positions P1-P8 around the platform 18. Each receiving member 58 is configured to receive an attachment or testing module at a respective one of the testing module positions P1-P8. Each receiving member 58 may define an opening 60 configured to receive a connection member of a testing module as described in more detail below. The connection members of the testing modules may generally be secured in the respective receiving members 58 with suitable fasteners such as bolts, but need not be. The receiving members 58 may be fixedly attached to the carriage 14. The receiving members 58 may be held at a distance away from the platform 18 by arms 62, or, in the case of the receiving member 58 at testing module position P8, may include a platform opening 64 with the receiving member 58 disposed below the platform 18 beneath the platform opening 64. FIG. 4 also shows slide positions S1-S3, which will be described in more detail below.

Referring still to FIGS. 1-4, the fixture 10 has a front side 36 where the fronts of the seat assemblies 12 being tested face, a rear side 34 where the backs of the seat assemblies 12 being tested face, a LH side 30 adjacent to where a LH seat assembly 12a to be tested is disposed, and an opposing RH side 32 adjacent to where a RH seat assembly 12b to be tested is disposed. Each of the LH side 30 and the RH side 32 may include a testing module mounted on the carriage 14 through the receiving members 58 at testing module positions P1 or P7. The rear side 34 may include one or more testing modules mounted to the carriage 14 through the receiving members 58 at testing modules P2-P6, P8. The receiving members 58 may be elongated hollow members fixedly attached to the carriage 14 and held at a distance away from the platform 18 by support arms 62. The receiving members 58 may be disposed substantially parallel to one another, but need not be.

Referring still to FIGS. 1-4, the front side 36 of the fixture 10 may include the rearward track 26 having a plurality of sliding test positions S1, S2 thereon. The rearward track 26 may optionally include visual markers to indicate the positioning of the sliding test positions S1, S2, or may include locking mechanisms to lock a sliding attachment in place at the desired sliding test position S1, S2. Sliding test position S3, which is depicted in FIG. 4 in two locations, will be described in more detail below.

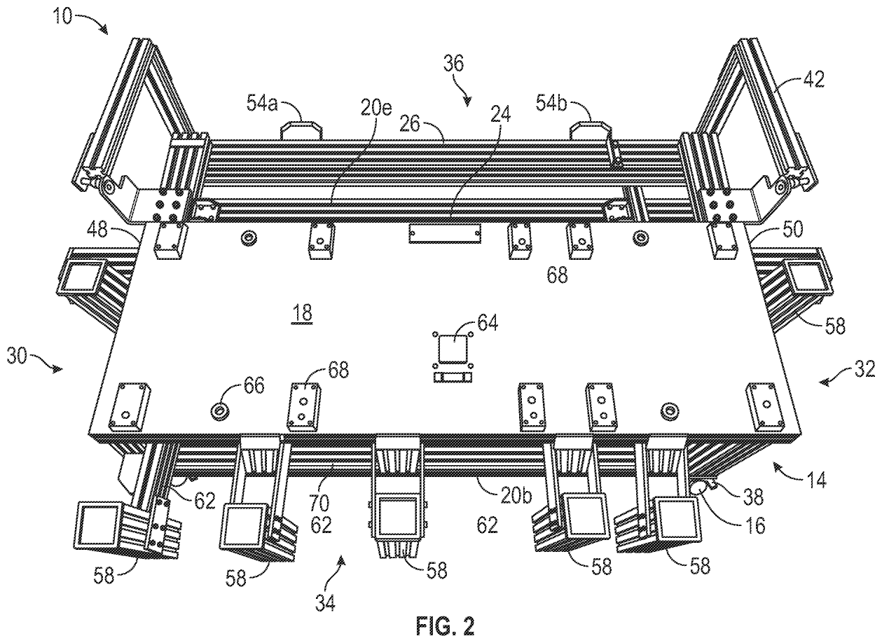

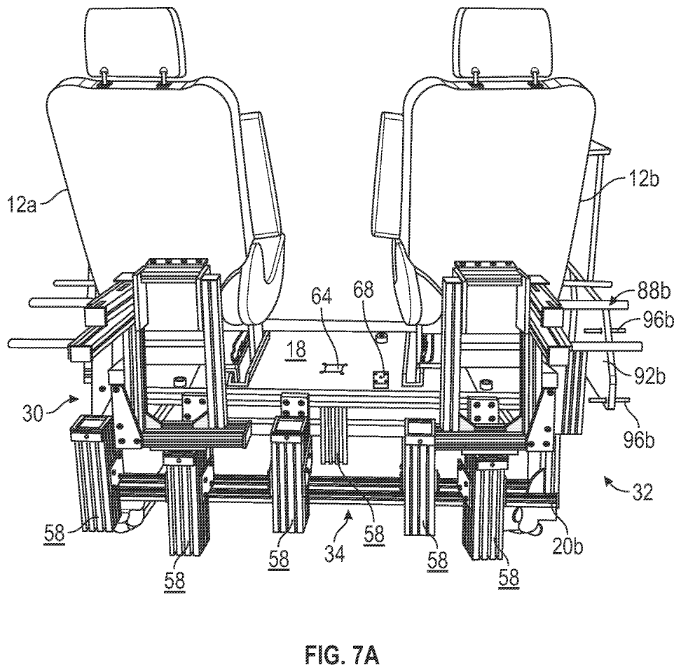

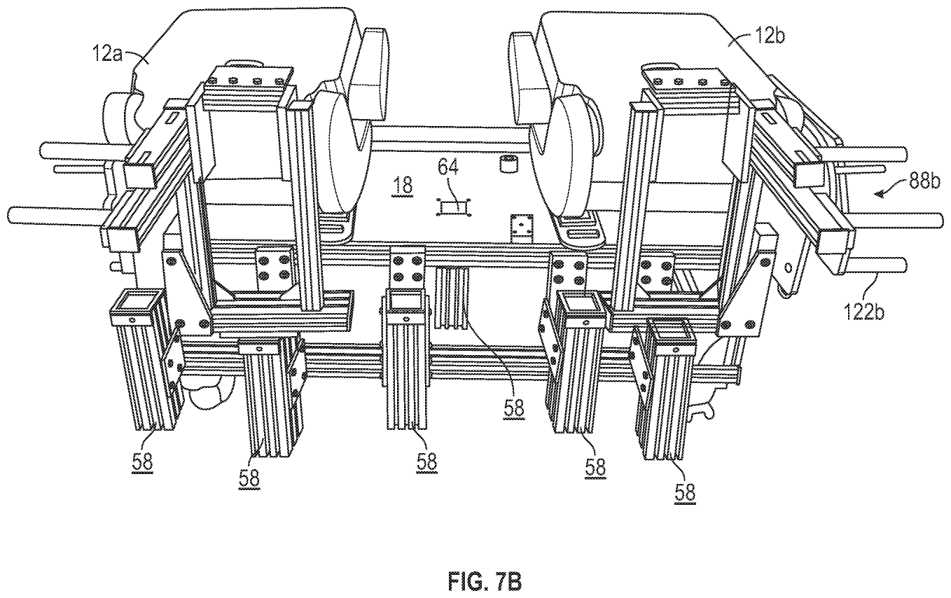

Referring specifically to FIGS. 1-2, the platform 18 may include a plurality of apertures 66 and a plurality of connection blocks 68. As best seen in FIG. 7, the connection blocks 68 are configured to receive base connectors of a seat assembly 12, thereby fastening the seat assembly 12 in place on the platform 18. In some embodiments, the platform 18 may include a sufficient number and configuration of connection blocks 68 for attaching both a LH seat assembly 12a and a RH seat assembly 12b to the platform 18. Though two seat assemblies 12a, 12b are described herein for exemplary purposes, it is understood that the fixture 10 is not limited to use with two seat assemblies 12, as the number of seat assemblies 12 is not limited. In other embodiments, the fixture 10 may be configured to test one seat assembly 12, or may be configured to test more than two seat assemblies 12. The number and configuration of connection blocks 68 on the platform 18 are therefore also customizable.

The carriage 14 and the platform 18 may be made from any suitable materials such as steel, metals, plastics, or wood, provided that the materials are capable of withstanding the weight imposed on them by seat assemblies 12a, 12b.

FIG. 4 illustrates the fixture 10 showing the testing positions P1-P7 of the receiving members 58, as well as the slide positions S1-S2 on the rearward track 26, disposed around seat assemblies 12a, 12b mounted on the fixture 10. As described above, each of the receiving members 58 at testing module positions P1-P7 may be fixedly attached to the carriage 14 of the fixture 10 and held at a distance away from the platform 18, and the receiving member 58 at testing module position P8 may include a platform opening 64 and be disposed beneath the platform 18. FIG. 4 further illustrates the positions of a tilt lever 72a, 72b, a tumble lever 74a, 74b, a strap 76a, 76b and a headrest (HR) button 78a, 78b, which are components of seat assemblies 12a, 12b along with the seat 80a, 80b, the seat back 82a, 82b, the armrest 84a, 84b, and the headrest 86a, 86b, while the seat assemblies 12a, 12b are connected to the fixture 10 on the platform 18. Uses for these components of the seat assemblies 12a, 12b will be described in more detail below. Furthermore, as noted above, though FIG. 4 illustrates two seat assemblies 12a, 12b, a right hand (RH) seat assembly 12b and a left hand (LH) seat assembly 12a. However, it is understood that the fixture 10 may accommodate one seat assembly, two seat assemblies, or more than two seat assemblies, and that the number of seat assemblies being tested with the fixture 10 is not particularly limited.

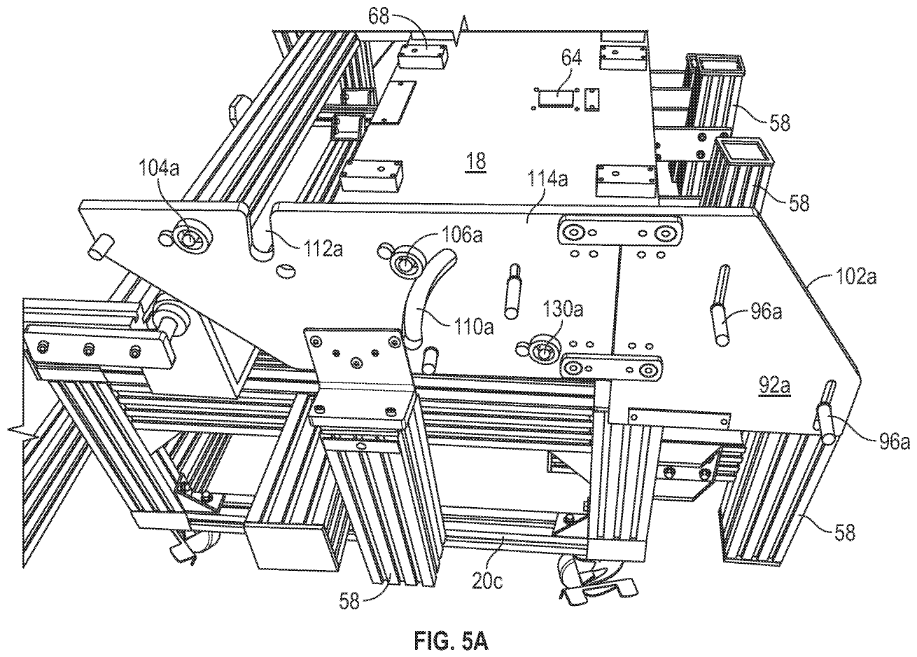

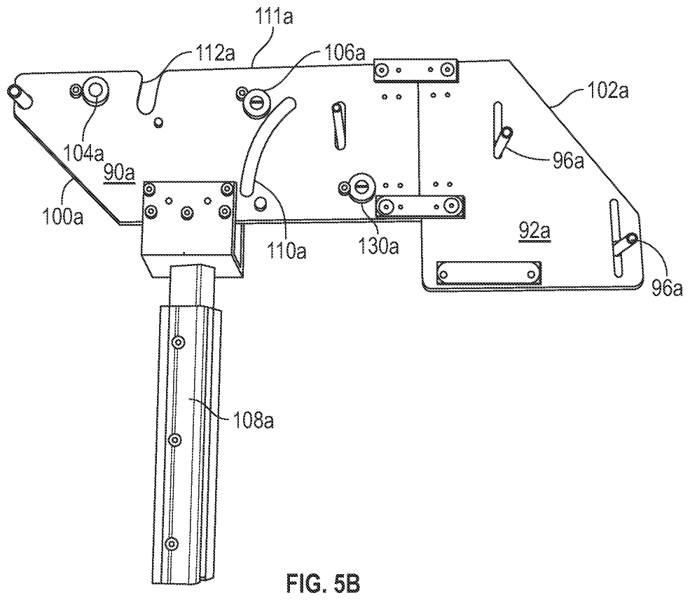

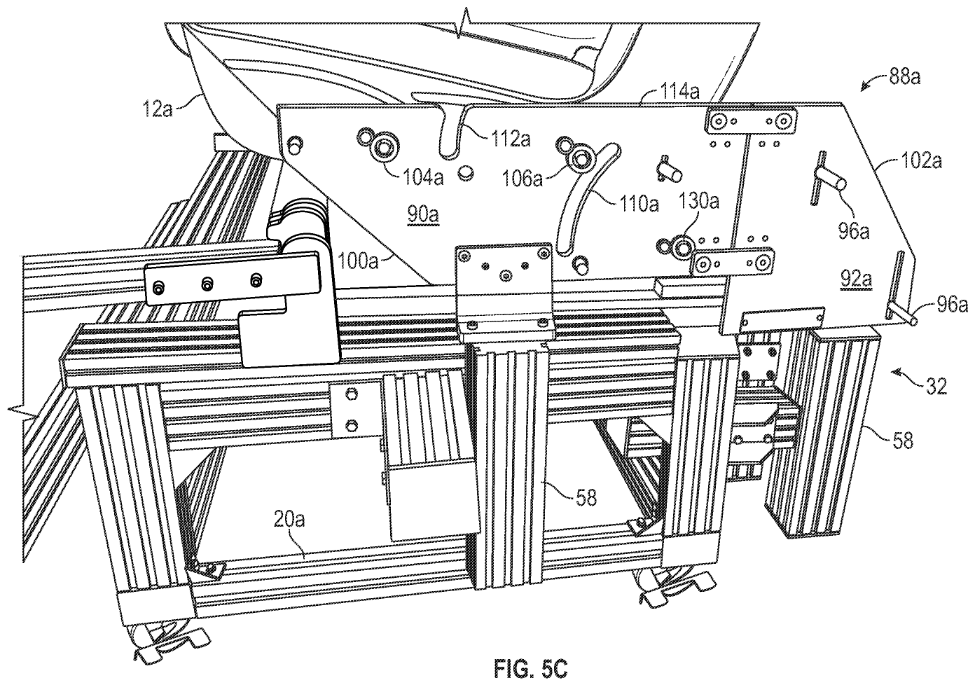

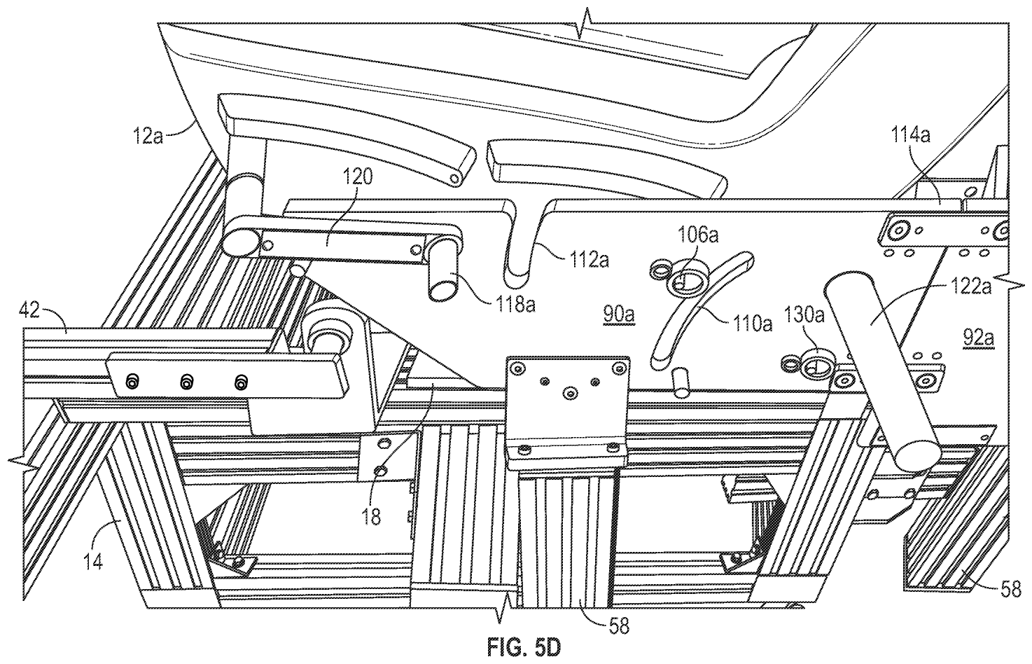

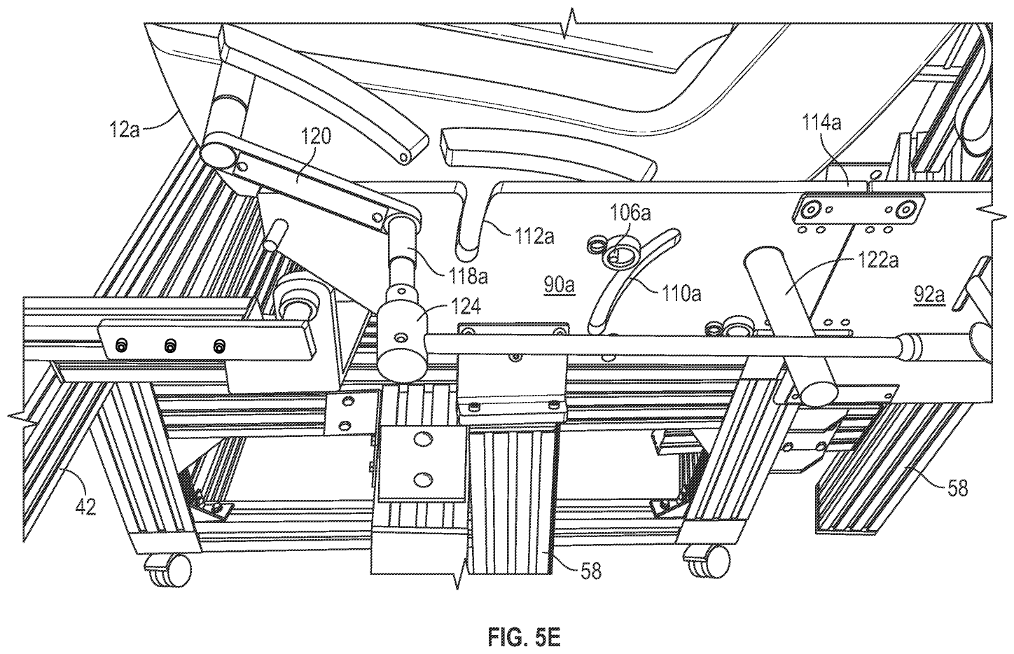

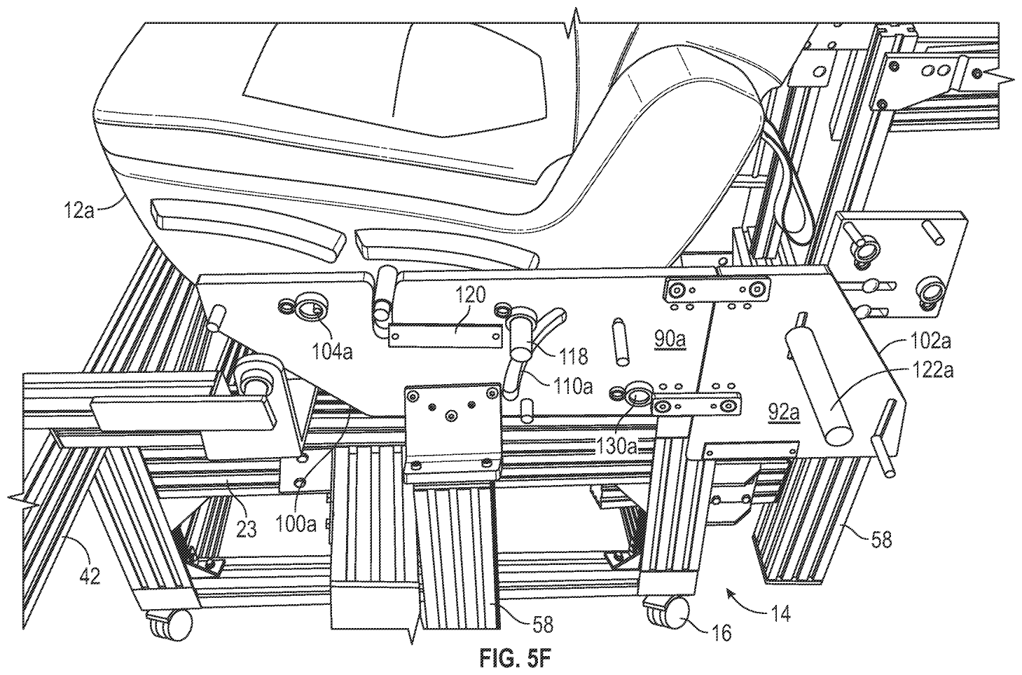

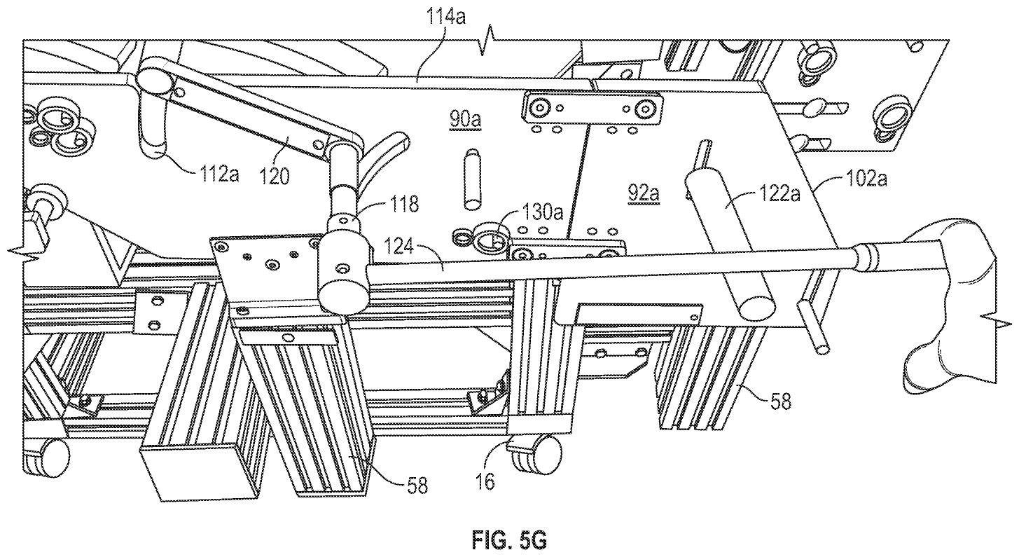

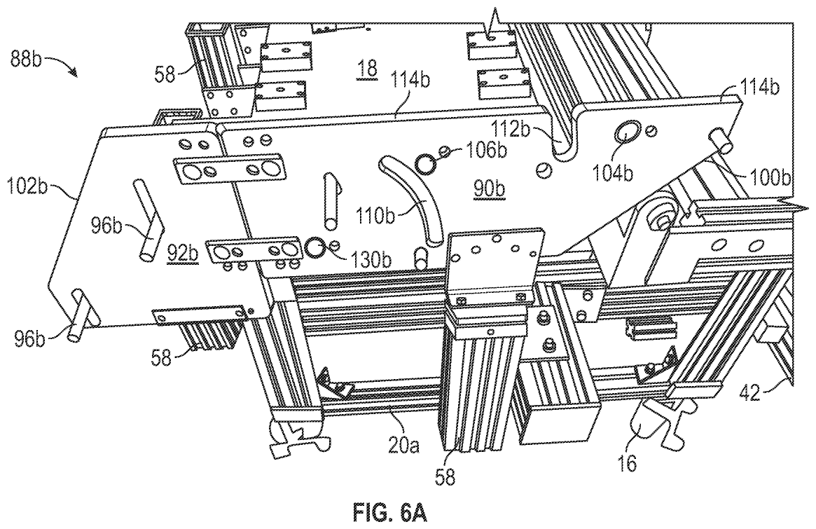

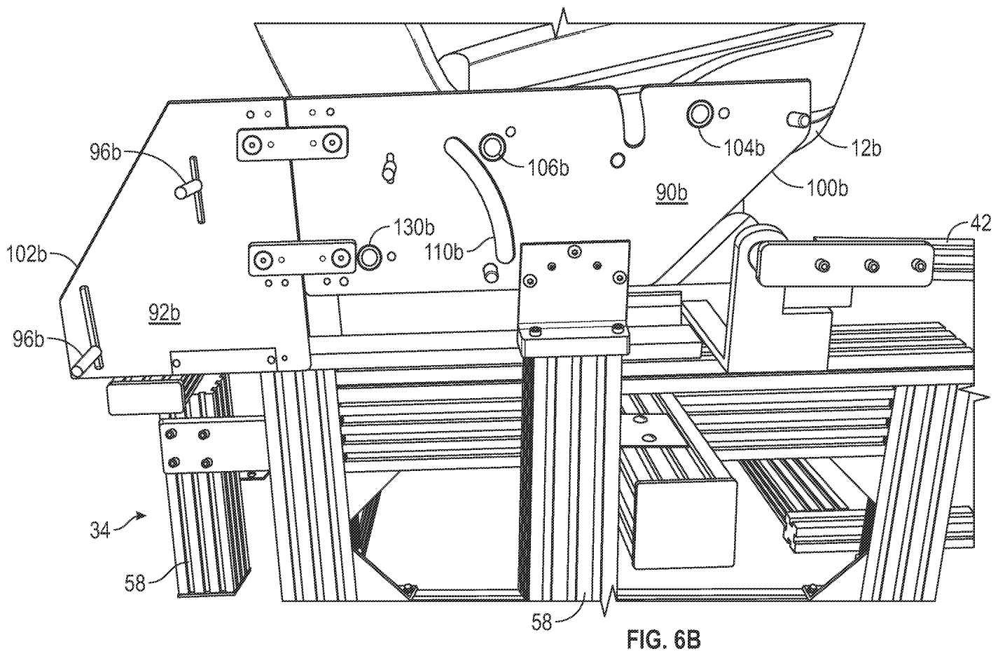

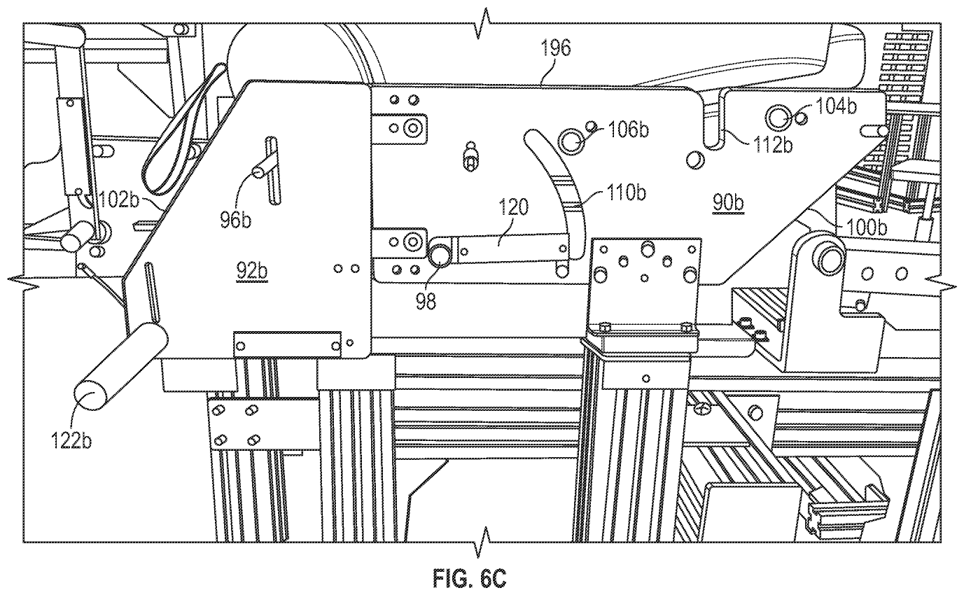

The fixture 10 may include a lever test module 88 that may be utilized on either the LH side or the RH side to perform various effort checks. Referring now to FIGS. 5-6, the receiving member 58 at testing module position P1 may be configured to receive a LH lever test module 88a (depicted in FIGS. 5A-5H), and the receiving member 58 at testing module position P7 may be configured to receive a RH lever test module 88b (depicted in FIGS. 6A-6C). The LH lever test module 88a and the RH lever test module 88b may be mirror images of each other, and in fact the same apparatus 88 may be used on each respective side to create the LH lever test module 88a and the RH lever test module 88b.

Referring specifically to FIGS. 5A-5G, the LH lever test module 88a may be formed from two interconnected parts 90a, 92a, the first part 90a being a metal plate with a curved slot 110a formed therethrough, and the second part 92a being a metal plate with one or more handles 96a extending outwardly from the LH lever test module 88a. The first part 90a may have a diagonal surface 100a toward the front side 36 of the fixture 10, and the second part 92a may have a diagonal surface 102a toward the rear side 34 of the fixture 10. The second part 92a may include a tilt lever aperture 104a disposed therein, a fold lever aperture 106a disposed therein, and a tumble lever aperture 130a disposed therein. The LH lever test module 88a is configured to be attached to the carriage 14 at the testing module position P1, such as through a connection member 108a that is inserted into the receiving member 58 at the testing module position P1. The connection member 108a may have a square cross section sized to fit snugly within the opening 60 in the receiving member 58 at the testing module position P1.

The LH lever test module 88a may further include a plurality of slots and apertures configured to receive handles, prongs, arms, hooks, or other components. The LH lever test module 88a may include a curved slot 110a, such as a halfmoon slot. The LH lever test module 88a may further include a straight slot 112a extending from a top edge 114a of the LH lever test module 88a.

Similarly, the RH lever test module 88b may be formed from two interconnected parts 90b, 92b, the first part 90b being a metal plate with a curved slot 110b formed therethrough, and the second part 92b being a metal plate with one or more handles 96b extending outwardly from the RH lever test module 88b. The first part 90b may have a diagonal surface 100b at the rear side 34 of the fixture 10, and the second part 92b may have a diagonal surface 102b at the front side 36 of the fixture 10. The second part 92b may include a tilt lever aperture 104b disposed therein, a fold lever aperture 106b disposed therein, and a tumble lever aperture 130b disposed therein. The RH lever test module 88b is configured to be attached to the carriage 14 through the receiving member 58 at the testing module position P7, such as through a connection member 108b being inserted into the opening 60 in the receiving member 58 at the testing module position P7. The connection member 108b may have a square cross section sized to fit snugly within the opening 60 of the receiving member 58 at the testing module position P7.

The LH lever test module 88b may further include a plurality of slots and apertures configured to receive handles, prongs, arms, hooks, or other components. The LH lever test module 88b may include a curved slot 110b, such as a halfmoon slot. The LH lever test module 88b may further include a straight slot 112b extending from a top edge 114b of the LH lever test module 88b.

As seen in FIG. 5C, the LH lever test module 88a may be inserted into the receiving member 58 at the testing module position P1 with a LH seat assembly 12a on the fixture 10 such that the apertures 104a, 106a in the LH lever test module 88a are positioned as desired with respect to components to be tested on the LH seat assembly 12a. The RH lever test module 88b may be similarly situated in the receiving member 58 at the testing module position P7 with respect to the RH seat assembly 12b, and be used to perform the same tests on the RH seat assembly 12b as described herein with respect to the LH seat assembly 12a, and vice versa.

As seen in FIGS. 5D-5E, the LH lever test module 88a may be used to perform a track lever test by inserting a rotatable handle 118 into the tilt lever aperture 104a and connecting an arm 120, such as a 127.8 mm arm, to the tilt lever aperture 104a such that the arm 120 is positioned to actuate a track lever 72a on the LH seat assembly 12a upon rotation of the arm 120 around the axis defined by the rotatable handle 118. The rotatable handle 118 can be torqued with a suitable lever arm 124 to accomplish such rotation. A long stop 122a is inserted into a forward stopping aperture 126a in the LH lever test module 88a to stop the rotation of the lever arm 124 at a desired position. The effort required to torque the track lever 72a may be measured by a suitable gauge 56.

As seen in FIGS. 5F-5G, the LH lever test module 88a may be used to perform a fold lever test by inserting a rotatable handle 118 into the fold lever aperture 106a and connecting an arm 120, such as a 127.8 mm arm, to the a rotatable handle 118 in the fold lever aperture 106a such that the arm 120 is positioned to actuate a fold lever on the LH seat assembly 12a upon rotation of the arm 120 around the axis defined by the rotatable handle 118 disposed in the fold lever aperture 106a. The rotatable handle 118 can be torqued with a suitable lever arm 124 to accomplish such rotation. A long stop 122a is inserted onto one of the handles 96a in the second part 92 of the LH lever test module 88a to stop the rotation of the lever arm 124 at a desired position. The effort required to torque the fold lever may be measured by a suitable gauge 56.

As seen in FIG. 6C, the curved slot 110b may receive an arm 120 that may rotate around an axis defined by a rotatable handle 118 inserted into a tumble lever aperture 130b of the RH lever test module 88b. This rotation may be utilized to perform a tumble test on a RH seat assembly 12b. The LH lever test module assembly 88a may be similarly utilized to perform a tumble test on a LH seat assembly 12a. The effort required to torque the tumble levers 74a, 74b may be measured by a suitable gauge 56.

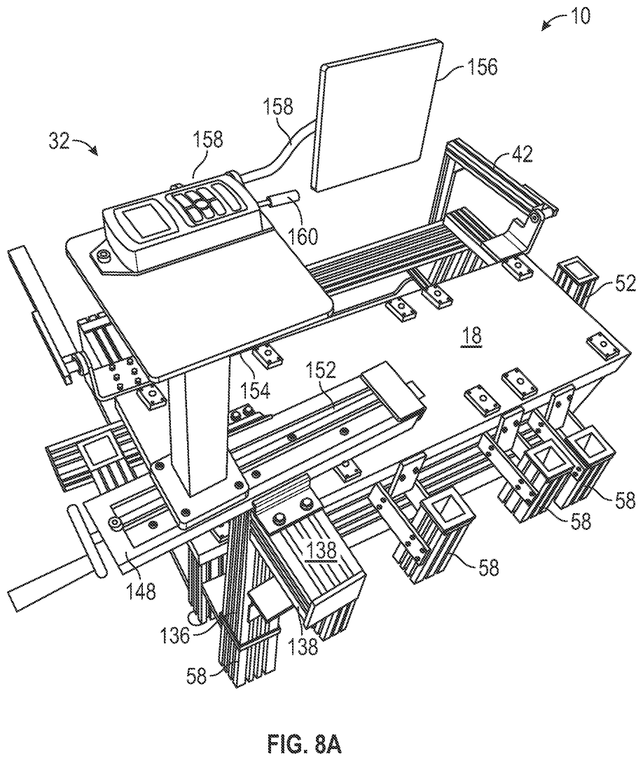

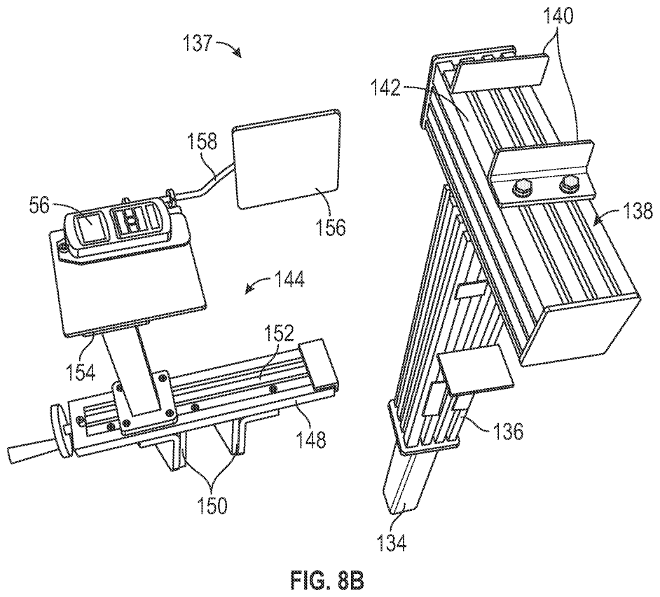

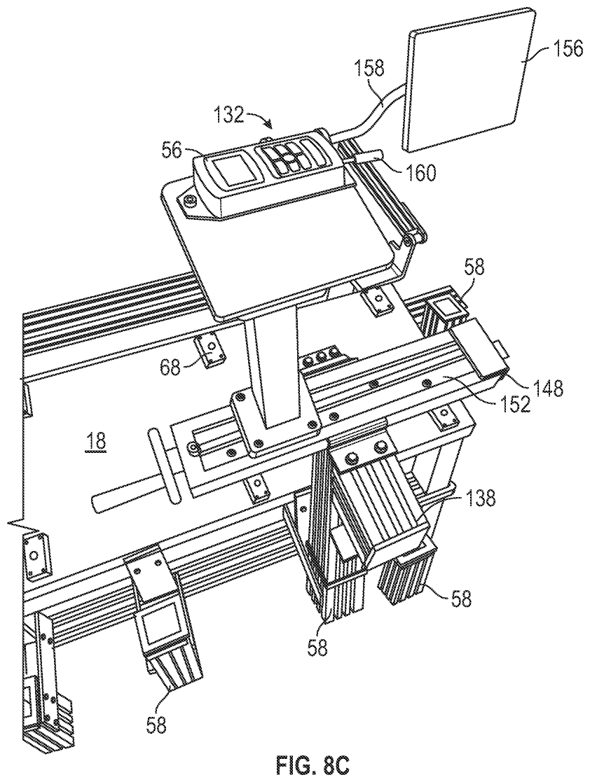

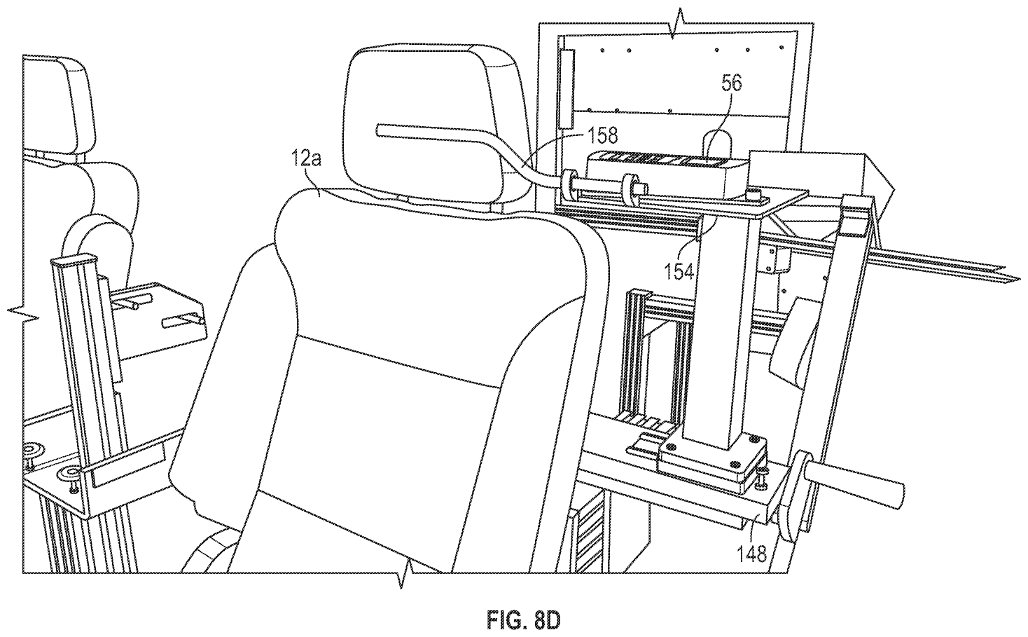

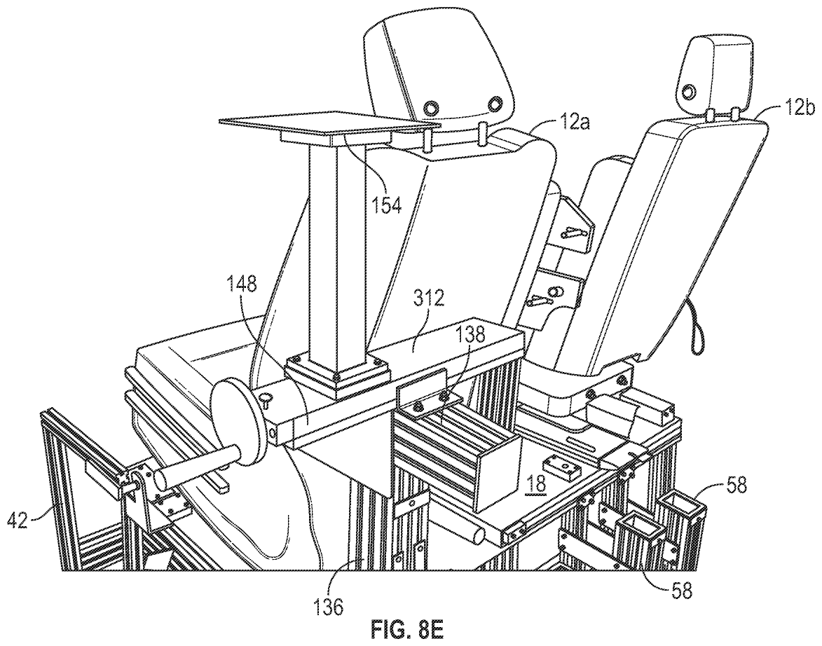

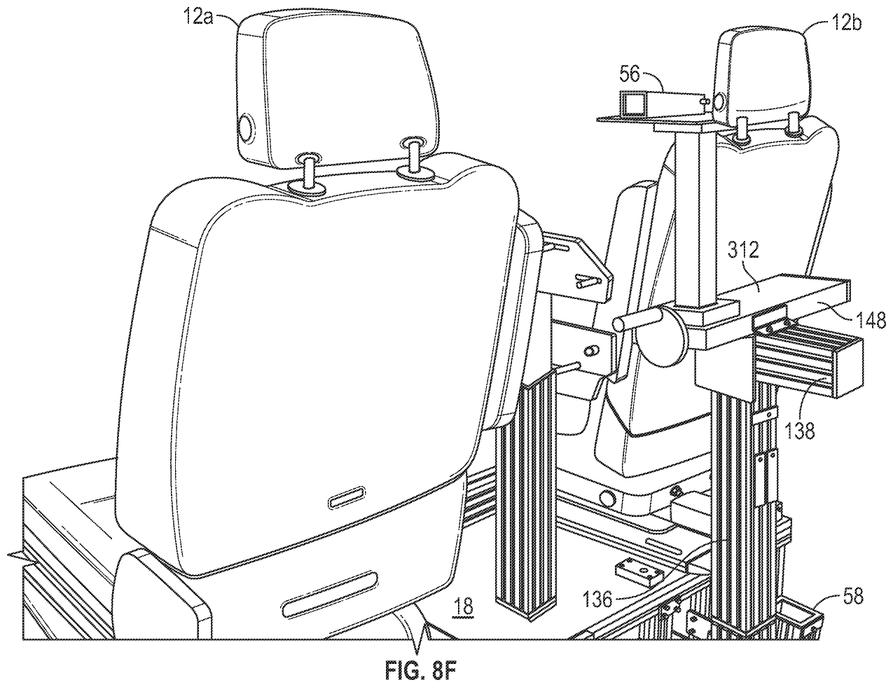

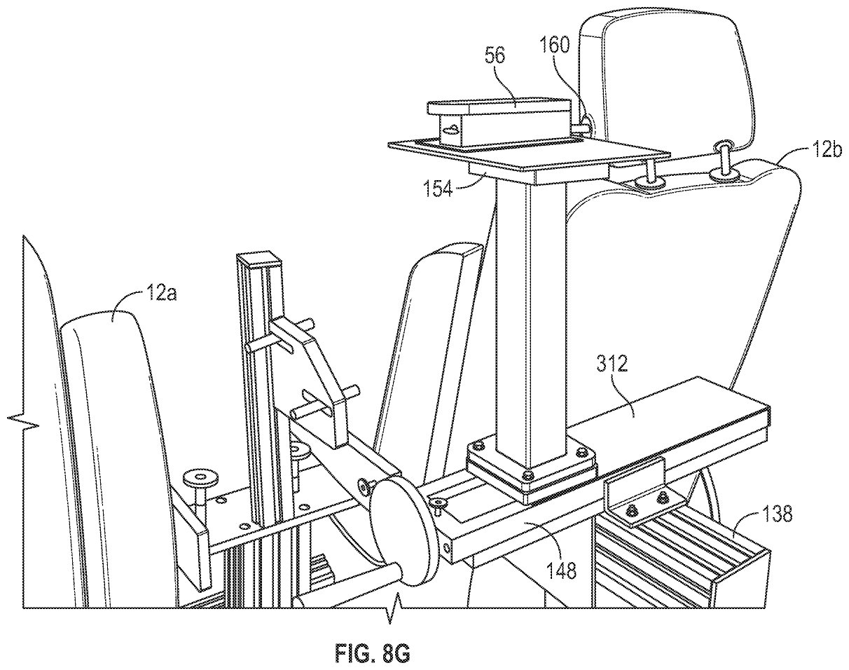

Referring now to FIGS. 8A-8E, the receiving members 58 at the testing module positions P2 or P5 may be configured to receive a headrest button test assembly 132. The headrest button test assembly 132 may be attached to the carriage 14 at the testing module position P2, for example, through a connection member 134 extending into the hollow receiving member 58 at the testing module position P2. When attached to the carriage 14 at the testing module position P2, the headrest button test assembly 132 may be configured in LH mode to test the button 78a on the LH seat assembly 12a. Referring now specifically to FIG. 8C, the headrest button test assembly 132 may also be attached to the carriage 14 at the testing module position P5, where it may be configured in RH mode to test the headrest button 78b on the RH seat assembly 12b.

Referring to FIG. 8B, the headrest button assembly 132 may include a base 136 with a connection member 132 configured to be inserted into a receiving member 58 (such as at the testing module positions P2 or P5), and a beam 138 extending in a substantially orthogonal manner to the connection member 132. The beam 138 may include upstanding arms 140 on a top surface 142 thereof. The headrest button assembly 132 may further include a slide member 144 with a gauge 56 thereon and a track member 148 mountable on the top surface 142 of the beam 138, with downstanding arms 150 on the track member 148 configured to extend along the sides of the beam 138. Together, the downstanding arms 150 and upstanding arms 140 of the track member 148 may connect the beam 138 to the slide member 144 in a stable manner, but in a manner that is also easily disconnected when desired.

The slide member 144 includes a track member 148 having a slidable track 152 therein with an elevated platform 154 movable along the slidable track 152. The track member 148 may be mounted on the beam 138. A force or torque sensor gauge 56 may rest on the elevated platform 154. An optional headrest support 156 may be connected to the elevated platform 154 by an arm 158, extending away at a distance therefrom. Alternatively, the arm 158 need not include the headrest support 156, as seen in FIG. 8D. Rather, FIG. 8D shows a headrest button assembly 132 from the front, where the arm 158 is positioned to stop the headrest from tilting forward beyond a desired amount. Thus, the arm 158 may act as a headrest tilt stop. The headrest button assembly 132 thus allows for a user to measure efforts involving a headrest 86 of a seat assembly 12 on the fixture 10, and to conveniently move between seat assemblies 12a, 12b on the fixture 10 so as to additionally measure efforts involving a headrest 86 of a second seat assembly 12a, 12b on the fixture 10 in a short amount of time. FIG. 8E depicts the headrest button assembly 132 being used to perform a headrest button test on a LH seat assembly 12a, where a nose pin 160 to the force meter 56 on the elevated platform 154 is pushing into headrest button 78a in the LH headrest 12a.

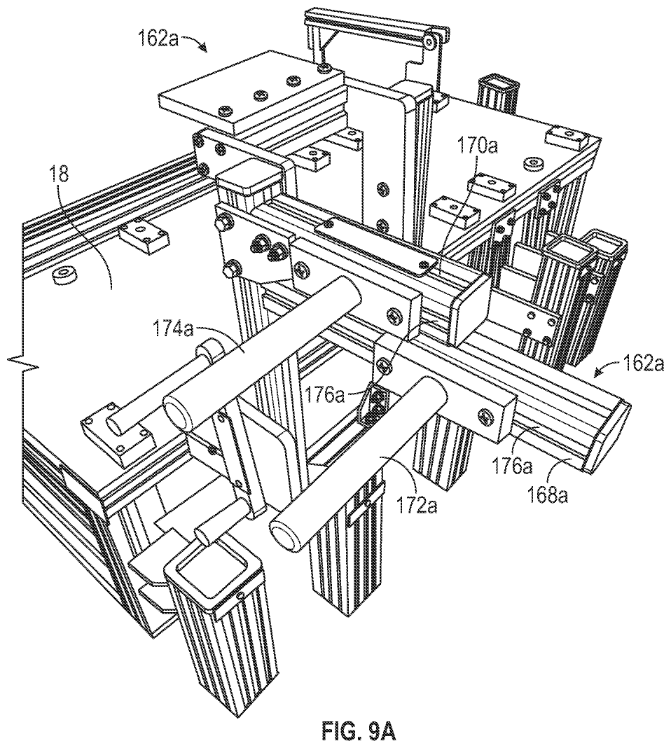

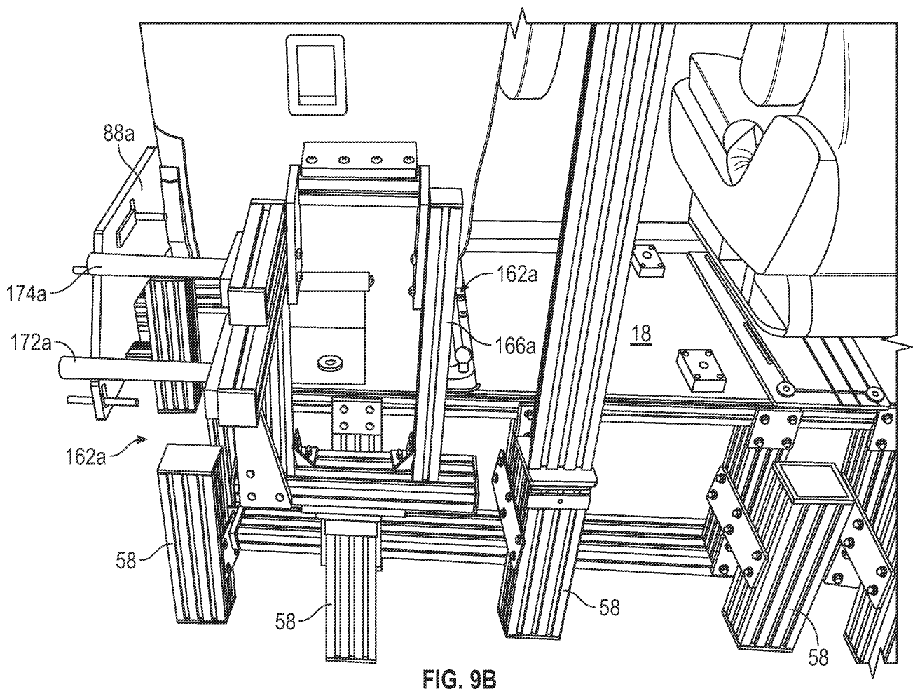

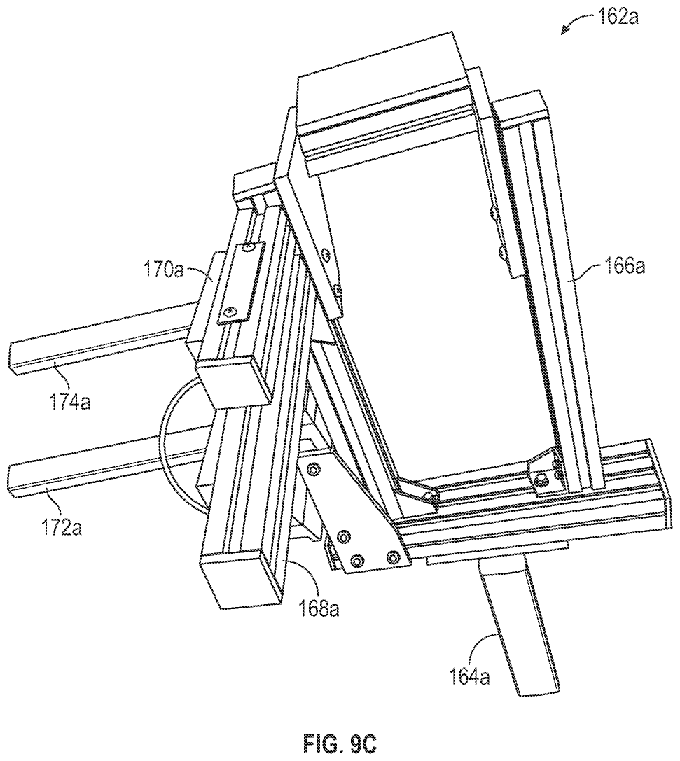

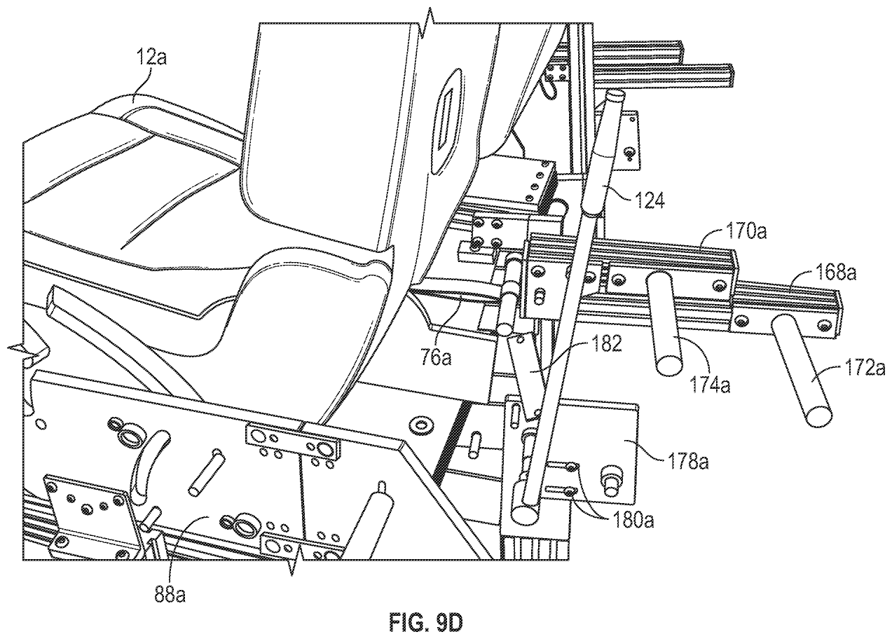

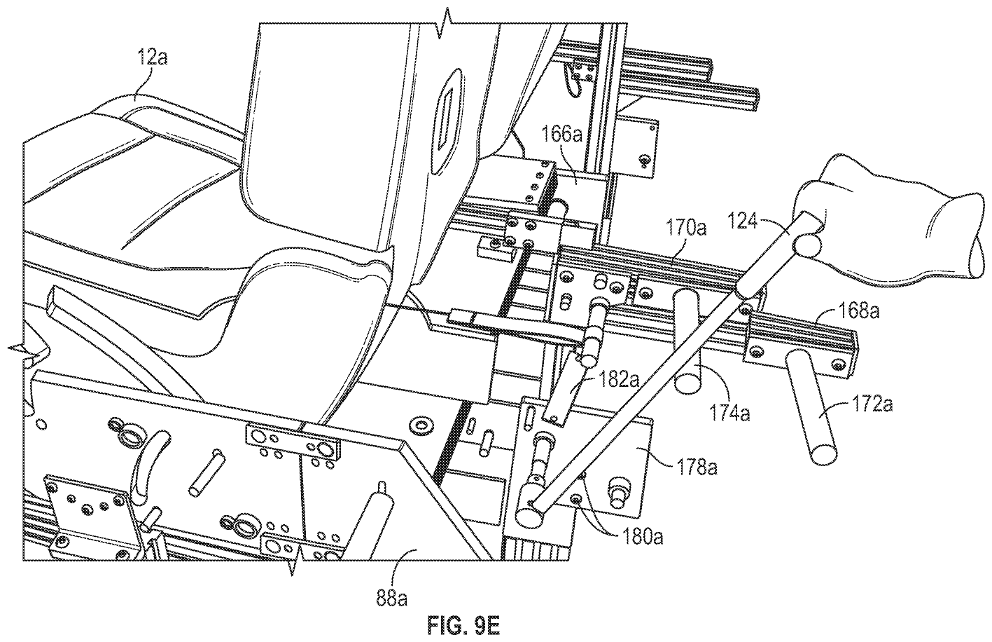

The fixture 10 may further include a strap pull assembly 162. Referring now to FIGS. 9A-9D, the receiving member 58 at the testing module position P3 may be configured to receive a LH strap pull assembly 162a. The LH strap pull assembly 162a may include a connection member 164a configured to be inserted into the hollow receiving member 58 at the testing module position P3, optionally with connectors such as bolts used, to attach the LH strap pull assembly 162a to the carriage 14. The LH strap pull assembly 162a further includes a bracket 166a mounted on the connection member 164a, with a first beam 168a and a second beam 170a fixedly attached to a left hand side of the bracket 166a. The first beam 168a includes a first long stop 172a, and the second beam 170a includes a second long stop 174a. Each of the first long stop 172a and second long stop 174a are slidable within a track 176a on the respective first beam 168a or second beam 170a. The right side of the bracket 166a further includes a plate 178a with one or more bushings 180a therein. As described in more detail below, and depicted in FIG. 9D, the first and second long stops 172a, 174a may be used to stop the rotation of a lever arm 124 used to rotate an arm 182a attached to one of the bushings 180a in the plate 178a. The bushing 180a is configured to receive the arm 182 having a handle 184 extending outwardly from the arm 182, where the arm 182 is rotatably connected relative to the bushing 180a. For example, a 200 mm arm may be placed into the bushing 180. The arm 182 may be connected to the strap 76a on the LH seat assembly 12a as seen in FIG. 9E. The arm 182 may include a handle 184 capable of being rotated by a suitable lever arm 124, such as depicted in FIGS. 9D-9E, to cause a rotation of the arm 182. The first long stop 170a can be used as a stop for the lever arm 124 at a desired position as depicted in FIG. 9E.

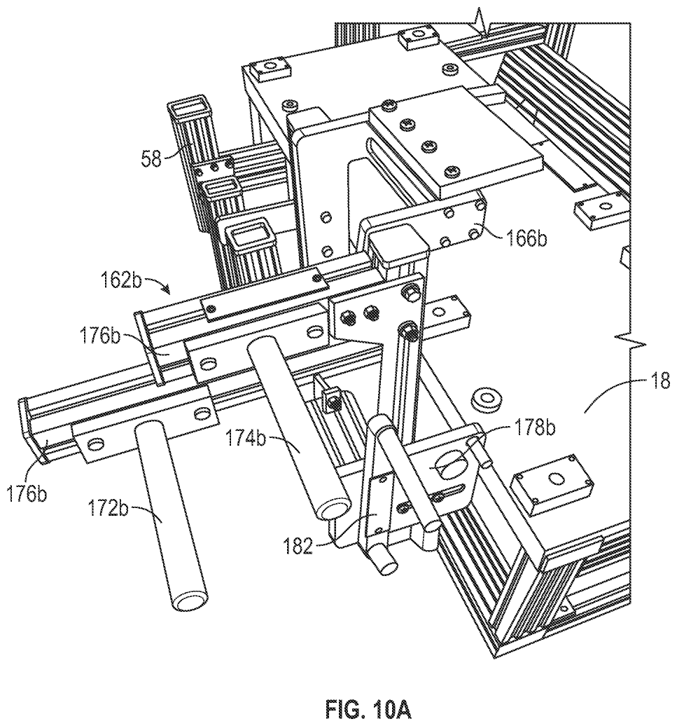

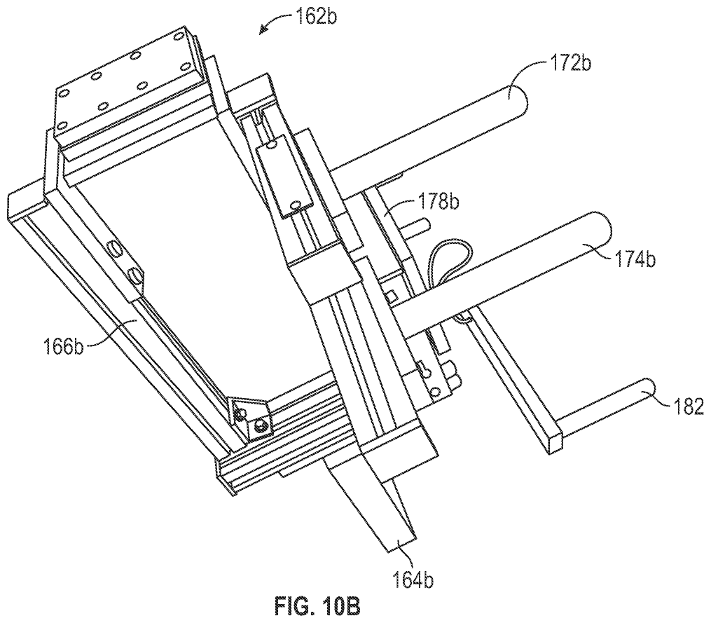

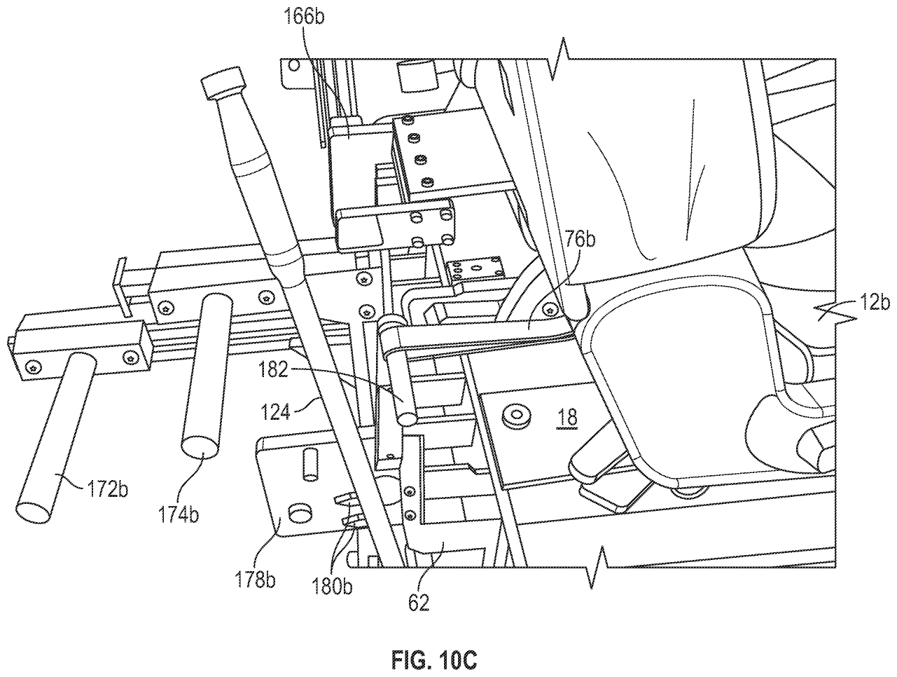

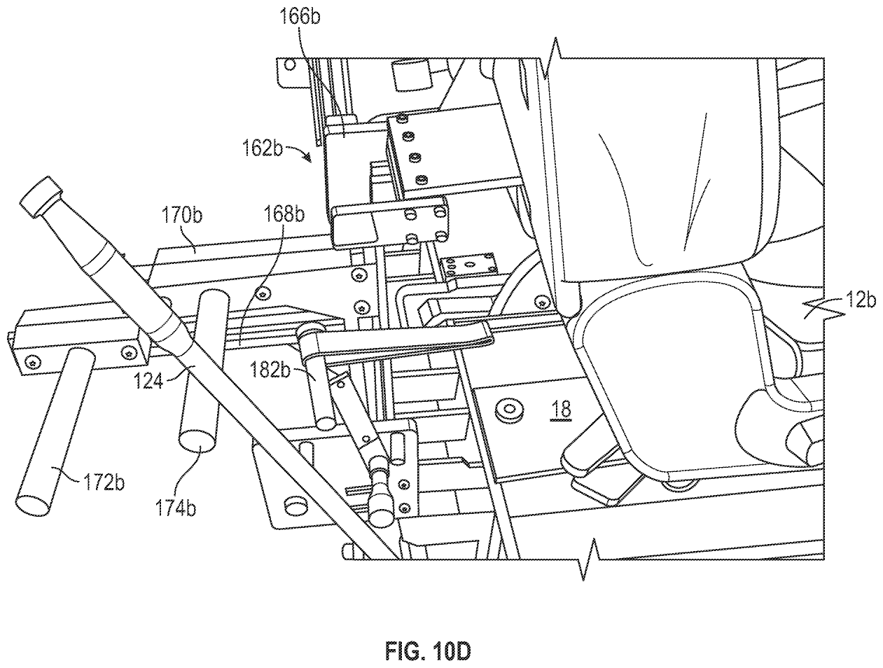

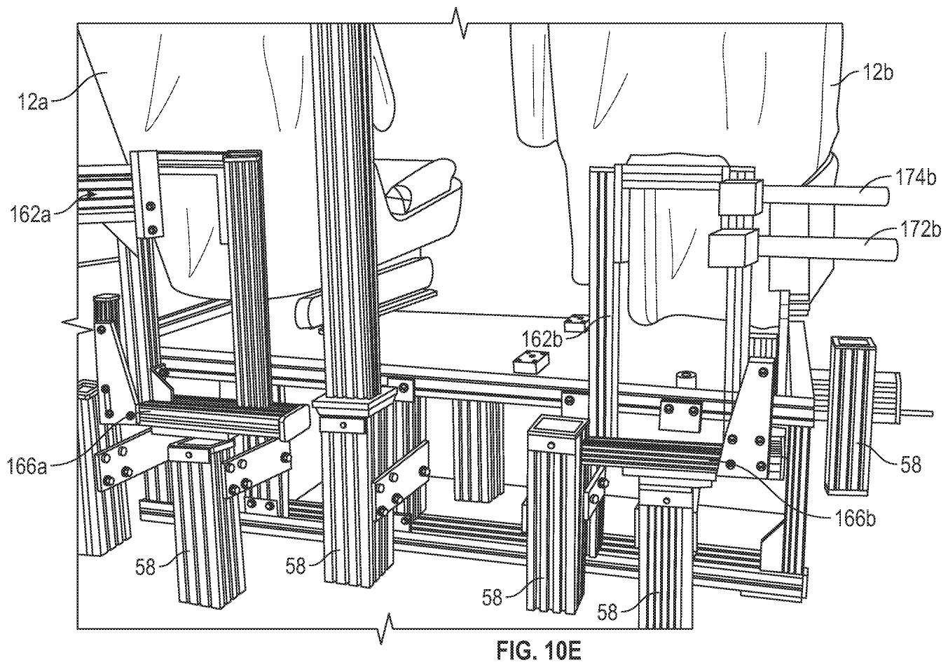

Referring now to FIGS. 10A-10E, the receiving member 58 at the testing module position P6 may be configured to receive a RH strap pull assembly 162b. The RH strap pull assembly 162b may be a mirror image of the LH strap pull assembly 162a. In fact, the same apparatus 162 may be used as the LH strap pull assembly 162a and the RH strap pull assembly 162b by simply moving the strap pull assembly 162 between positions on the LH side 30 and the RH side 32 of the fixture 10. The RH strap pull assembly 162b may include a connection member 164b configured to be inserted into the hollow receiving member 58 at the testing module position P6, optionally with connectors such as bolts used, to attach the RH strap pull assembly 162b to the carriage 14. The RH strap pull assembly 162b further includes a bracket 166b mounted on the connection member 164b, with a first beam 168b and a second beam 170b fixedly attached to a right hand side of the bracket 166b. The first beam 168b includes a first long stop 172b, and the second beam 170b includes a second long stop 174b. Each of the first long stop 172b and second long stop 174b are slidable within a track 176b on the respective first beam 168b or second beam 170b. The right side of the bracket 166b further includes a plate 178b with one or more bushings 180b therein. The first and second long stops 172b, 174b may be used to stop the rotation of an arm 182 attached to a bushing 180b in the plate 178b. The bushing 180b is configured to receive an arm 182 having a handle 184b extending outwardly from the arm 182, where the arm 182 is rotatably connected relative to the bushing 180b. For example, a 200 mm arm may be placed into the bushing 180b. The arm 182 may be connected to the strap 76b on the RH seat assembly 12b, as seen in FIG. 10E. The arm 182 may include a handle 184b capable of being rotated by a suitable lever arm 124, such as depicted in FIGS. 10C-10D, to cause a rotation of the arm 182. The first long stop 172b can be used as a stop for the lever arm 124 at a desired position as depicted in FIG. 10D.

As seen in FIG. 9D, the handle 184a of the LH strap pull assembly 162a may be connected to the strap 76a of the LH seat assembly 12a. As seen in FIG. 10C, the handle 184b of the RH strap pull assembly 162b may be connected to the strap 76b of the RH seat assembly 12b. In use, the LH strap pull assembly 162a may be torqued with a suitable lever arm 124 to cause a pulling force on the strap 76a, and the RH strap pull assembly 162b may be torqued with a suitable lever arm 124 to cause a pulling force on the strap 76b. The effort involved in doing this may be measured by a suitable meter or gauge 56.

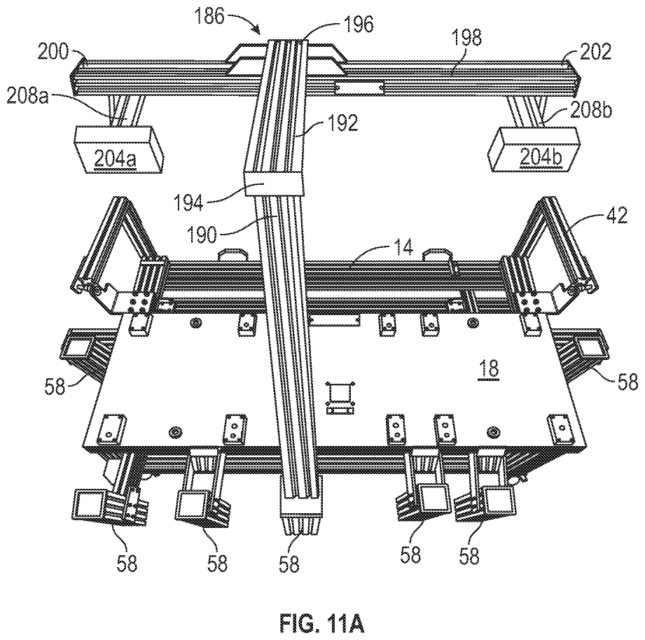

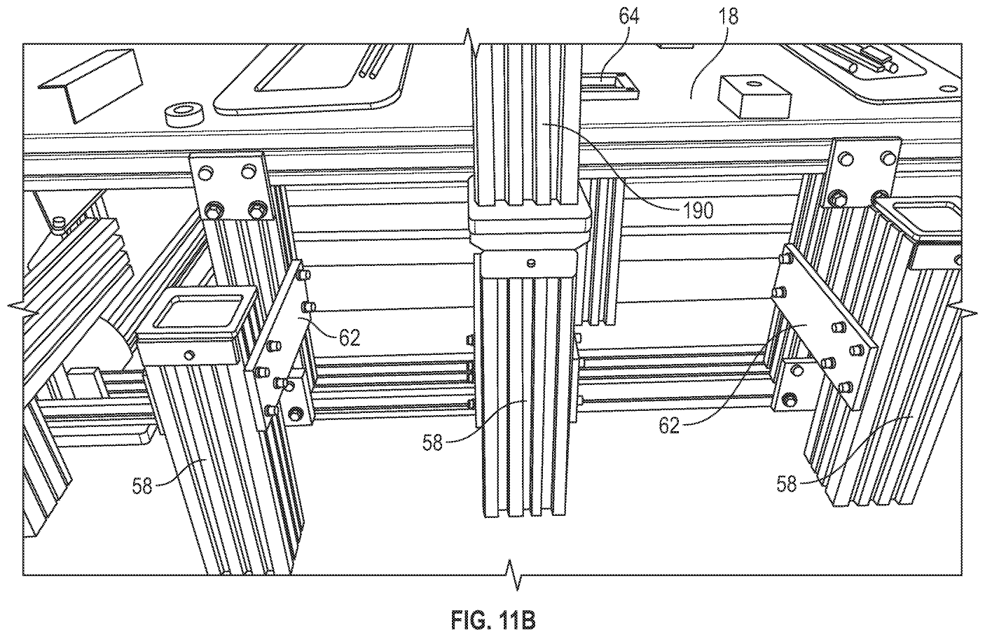

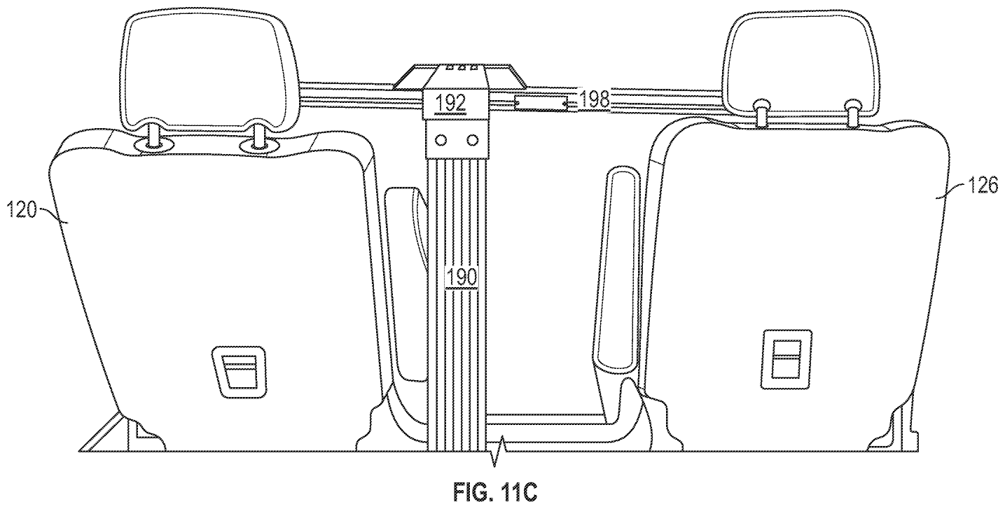

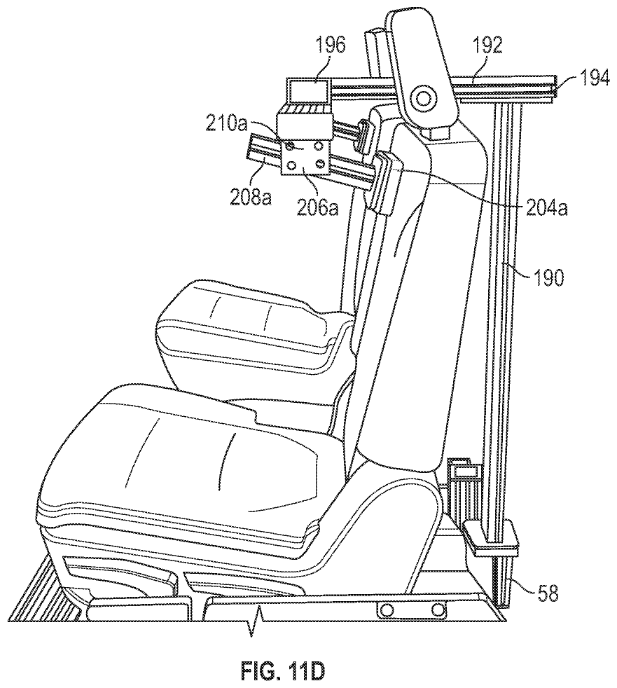

Referring now to FIGS. 11A-11D, the receiving member 58 at the testing module position P4 may be configured to receive an anti-tilt tooling assembly 186. The anti-tilt tooling assembly 186 may include a connection member 188 configured to be inserted into the hollow receiving member 58 at the testing module position P4. The anti-tilt tooling assembly 186 may include an elongated shaft 190 rising a height above the receiving member 58 at the testing module position P4, in an area behind the seat assemblies 12a, 12b. At the top of the elongated shaft 190, the elongated shaft 190 is connected to a bridging member 192 that extends from the elongated shaft 190 in the direction of the front side 36 of the fixture 10, toward and across the seat assemblies 12a, 12b when present. The bridging member 192 has a first end 194 at or near the elongated shaft 190 and a second end 196 disposed above the platform 18, between RH and LH seat assemblies 12a, 12b when present on the platform 18. The second end 196 connects to a cross member 198 that extends along the direction of from the RH side 32 of the fixture 10 to the LH side 30 of the fixture 10. The cross member 198 defines a LH side 200 and a RH side 202. A LH stopper 204a is mounted to the LH side 200 of the cross member 198, and a RH stopper 204b is mounted to the RH side 202 of the cross member 198. The LH stopper 204a and RH stopper 204b may be used for fold release tests. The LH stopper 204a and RH stopper 204b may be made from a plastic or foam material. The LH stopper 204a and RH stopper 204b may be mounted at the respective sides of the cross member 198 through an adjustable mechanism on each side involving a bracket 206a, 206b and an arm 208a, 208b that is slidable through the bracket 206a, 206b. The brackets 206a, 206b can be tightened with fasteners 210 to clamp the arms 208a, 208b in place, thereby fixing the respective stopper 204a, 204b in place. Thus, the anti-tilt tooling assembly 186 is configured to provide stopping mechanisms for seat backs 82 of seat assemblies 12 disposed on the fixture 10. As depicted in FIG. 11D, the seat assemblies 12a, 12b may be tilted forward to the point where they meet the LH stopper 204a and RH stopper 204b which prevent further tilting of the seat assemblies 12a, 12b during testing.

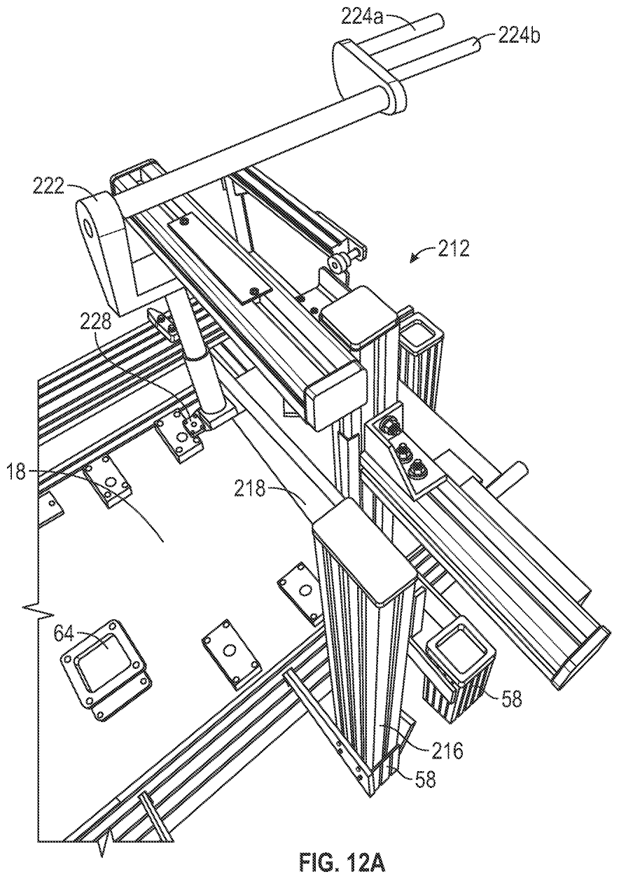

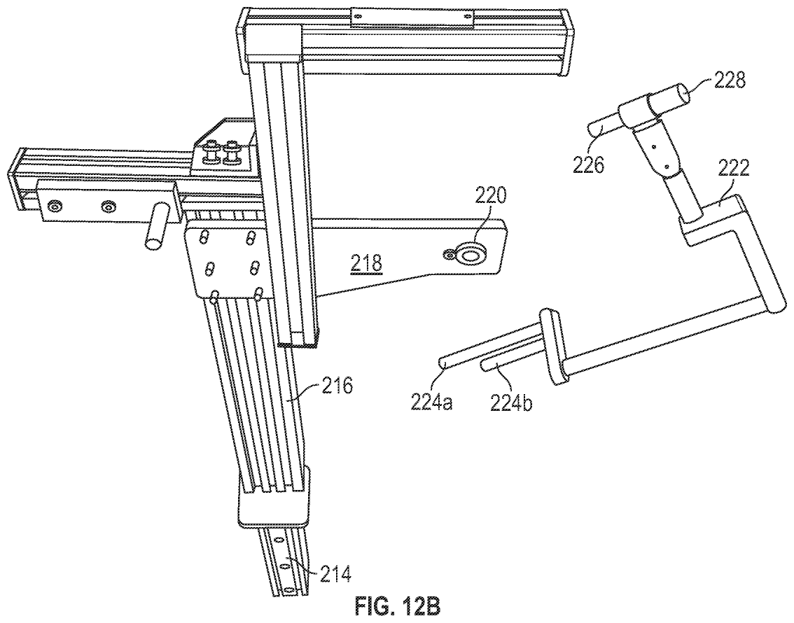

Referring now to FIGS. 12A-12B, the receiving member 58 at the testing module position P5 may be configured to receive an armrest bench seat test assembly 212. The armrest bench seat test assembly 212 may include a connection member 214 configured to be inserted into the hollow receiving member 58 at the testing module position P5 to attach the armrest bench seat test assembly 212 to the fixture 10. The armrest bench seat test assembly 212 may include an elongated shaft 216 extending from the connection member 214, a mounting arm 218 with an aperture 220 therein extending from the elongated shaft 216, and an attachment 222 with two prongs 224a, 224b. The attachment 222 may be rotatably attached to the mounting arm 218 by a rod 226 on the attachment 222 being inserted into the aperture 220 of the mounting arm 218. When in place on the fixture 12 at testing module position P5, the prongs 224a, 224b of the attachment 222 extend in a direction toward the RH side 32 of the fixture 12 from the testing module position P5, as seen in FIG. 12A. A handle 228 opposing the rod 226 may be utilized to rotate the rod 226 in the aperture 220 and thereby rotate the attachment 222 with two prongs 224a, 224b around the axis defined by the rod 226.

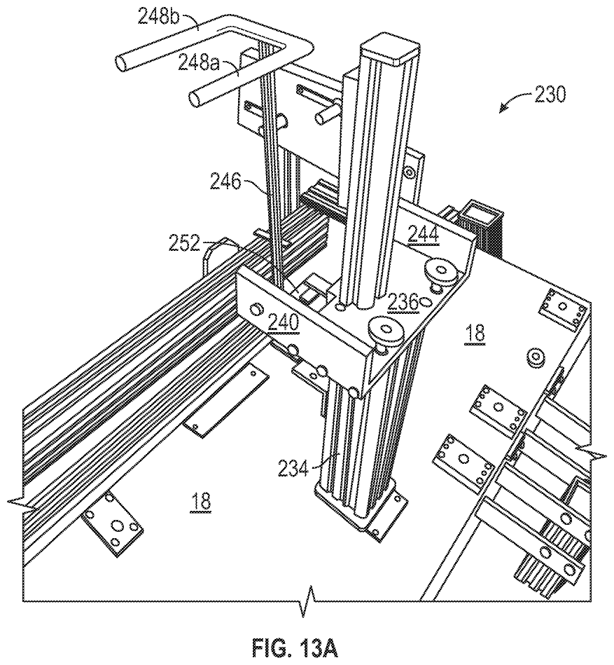

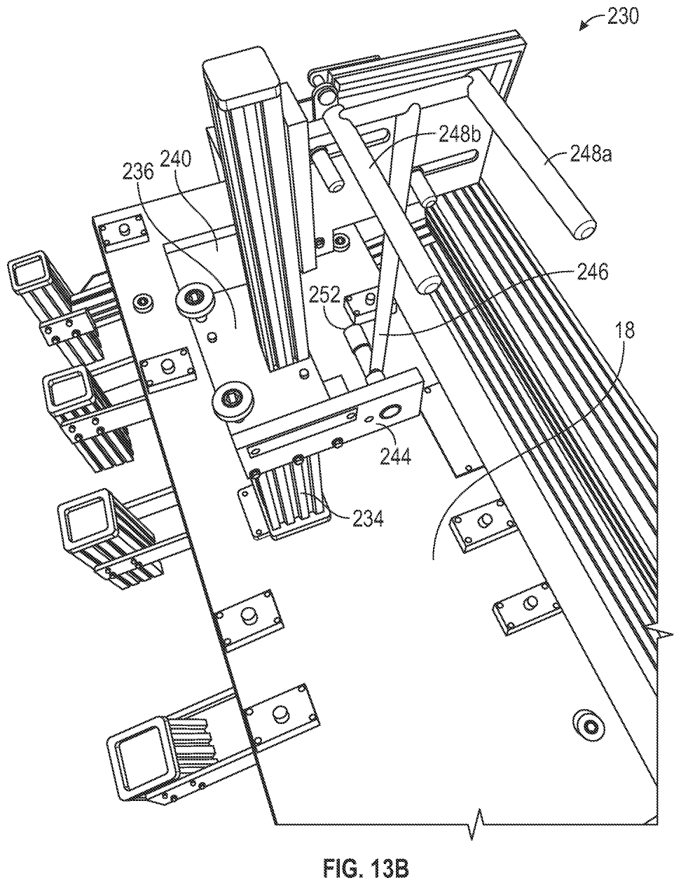

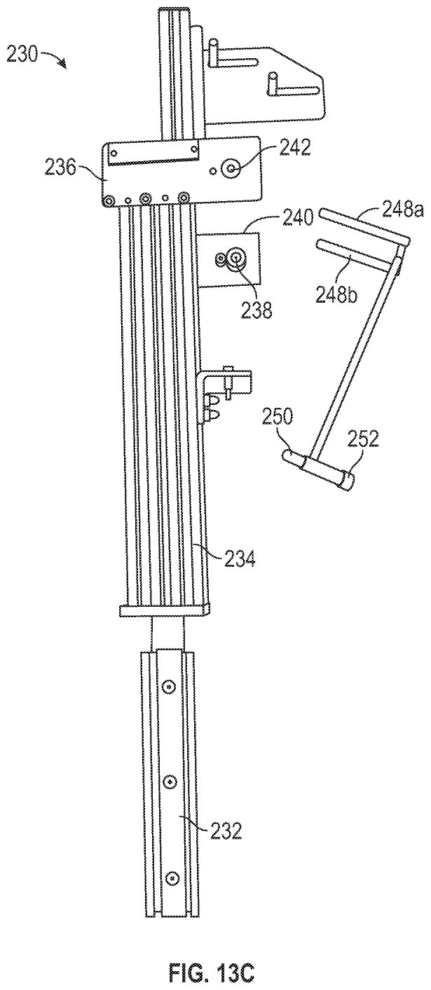

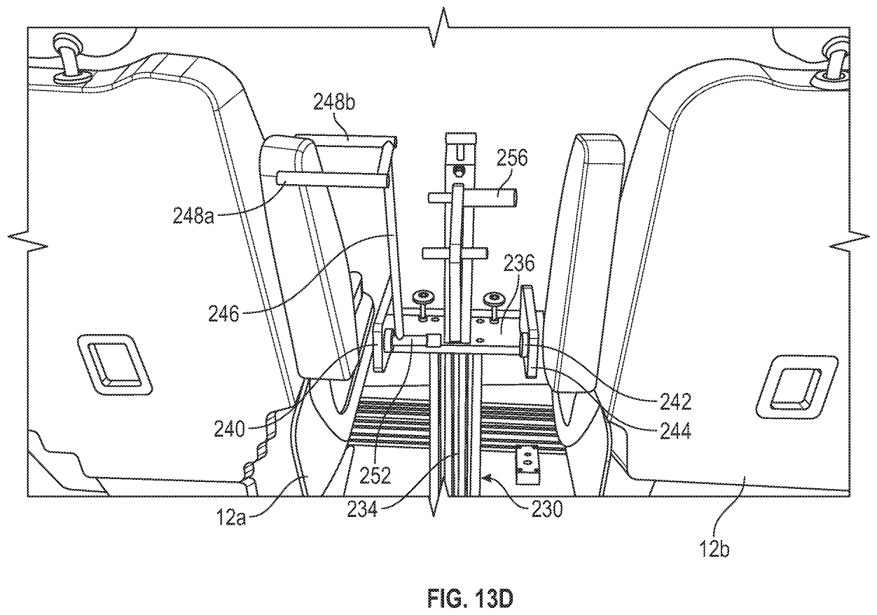

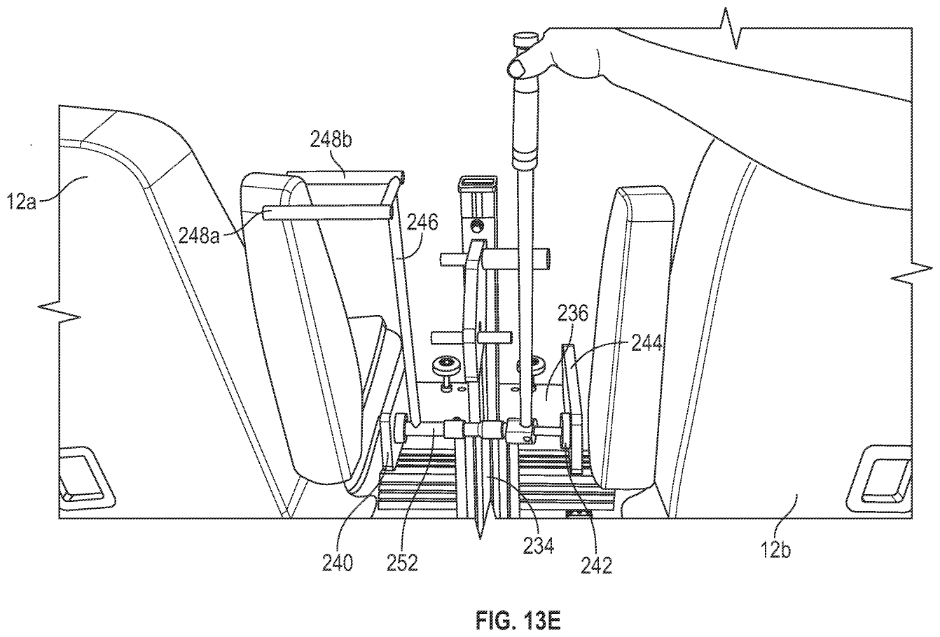

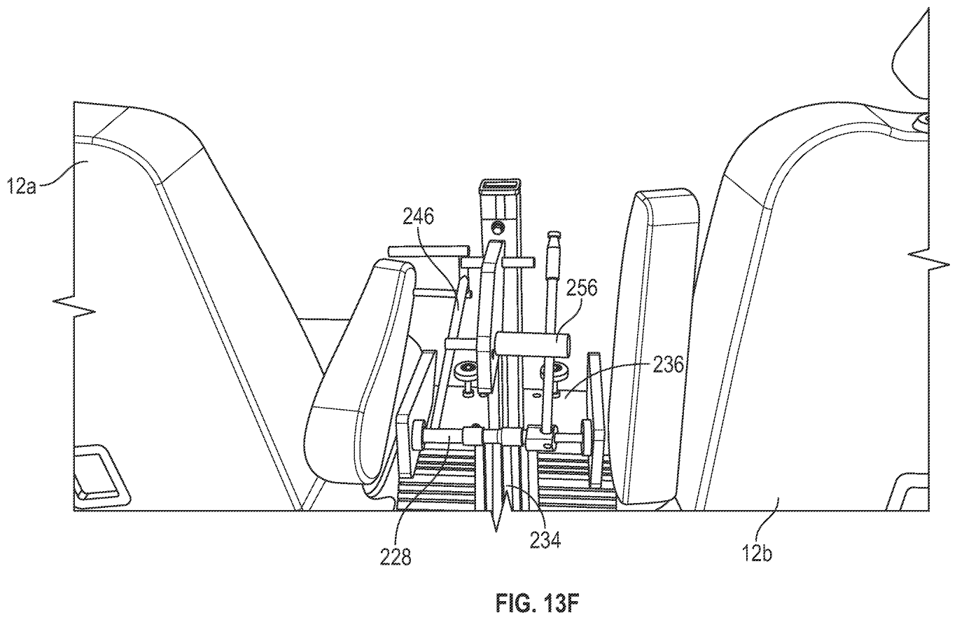

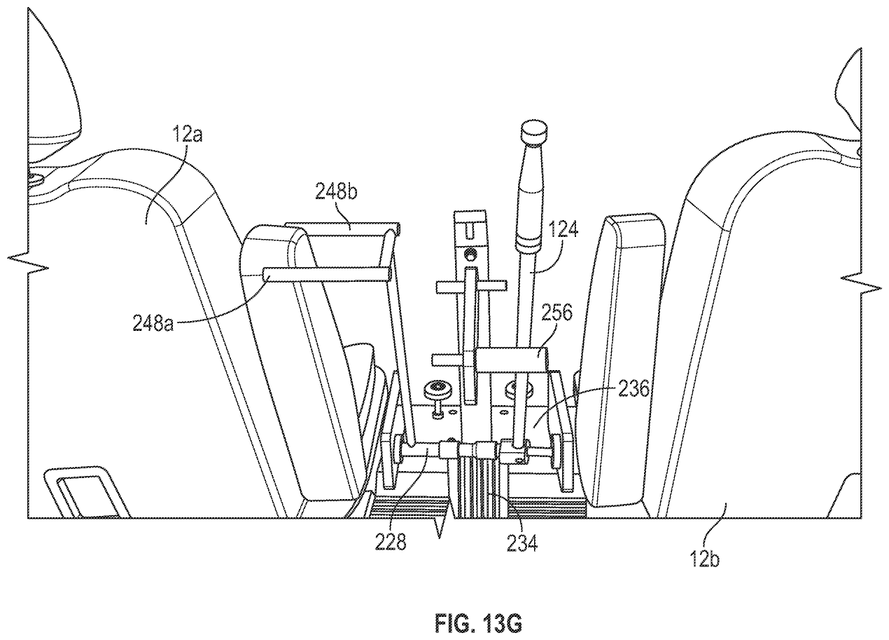

Referring now to FIGS. 13A-13D, the receiving member 58 at the testing module position P8 may be configured to receive a captain armrest test assembly 230. The receiving member 58 at the testing module position P8 may be formed from the platform opening 64, between the LH seat assembly 12a and RH seat assembly 12b when present, with a hollow receiving member disposed below the platform 18 aligned with the platform opening 64 as seen in FIGS. 7A-7B. The captain armrest test assembly 230 may include a connection member 232 configured to be inserted into the platform opening 64 and associated receiving member 58 at the testing module position P8 to connect to the fixture 10.

The captain armrest test assembly 230 may include an elongated member 234 extending from the connection member 232, and holding a bracket 236 a desired height above the connection member 232 (i.e., a desired height above the platform 18 when inserted into the receiving member 58 at the testing module position P8). The bracket 236 includes a first aperture 238 on a first side 240 and a second aperture 242 on an opposing second side 244. The captain armrest test assembly 230 may include a test arm 246 having two prongs 248a, 248b extending in a manner substantially parallel to one another. The test arm 246 may be clamped into the bracket 236 so as to hold the test arm 246 in place relative to the connection member 232 and, when connected at the testing module position P8, relative to the fixture 10. The test arm 246 may be rotatably connected to the bracket 236 at either the first aperture 238 or the second aperture 242. The test arm 246 may include a connecting rod 250 configured to be inserted into either of the first aperture 238 or the second aperture 242 in the bracket 236. The captain armrest test assembly 230 may be converted between a RH mode and a LH mode, for testing a RH seat assembly 12b or a LH seat assembly 12a, respectively, by changing the aperture 238, 242 in which the test arm 246 is attached, and thereby changing the direction in which the two prongs 248a, 248b extend relative to the elongated member 234. Thus, the captain armrest test assembly 230 is configured to be attached to the fixture 10 in a position between a RH seat assembly 12b and a LH seat assembly 12a and extend two prongs 248a, 248b in the direction of either the RH seat assembly 12b or the LH seat assembly 12a, when present. The test arm 246 can be rotated relative to the bracket 236 by applying a torque to a handle 228.

In use, the test arm 246 may hook onto the arm rest 84 of either seat assembly 12a, 12b, as shown in FIG. 13D with respect to a LH seat assembly 12a for example purposes, and be rotated to a desired extent through the use of a lever arm 124 or other torqueing device, as depicted in FIGS. 13E-13G. A stop handle 256 on the elongated member 234 above the bracket 236 acts to stop the rotation of the lever arm 124 at a desired position, as seen in FIG. 13G. The effort involved in this process may be measured by a suitable meter or gauge 56.

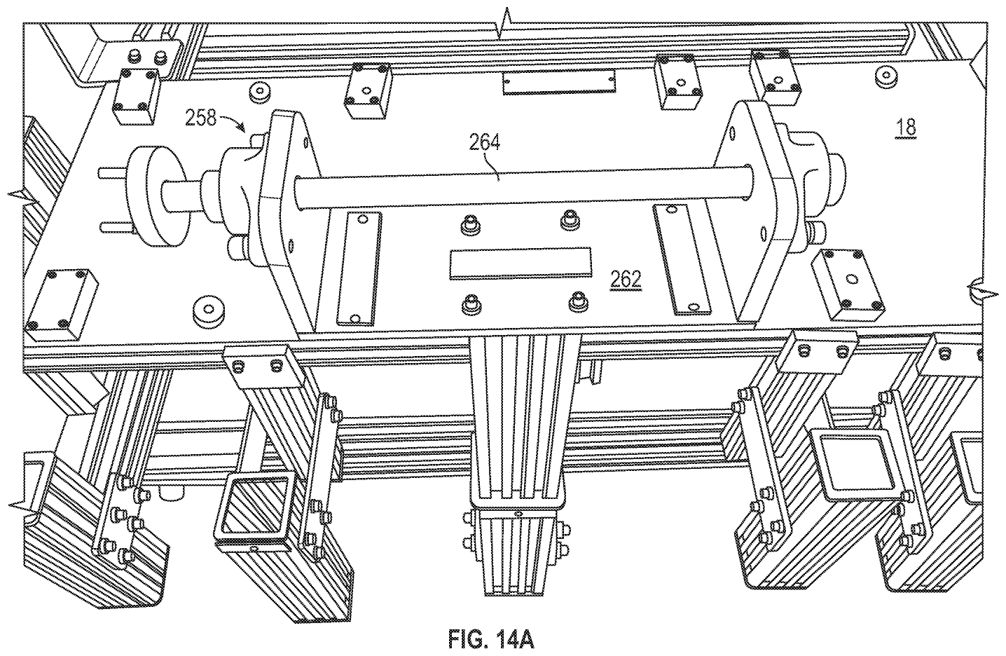

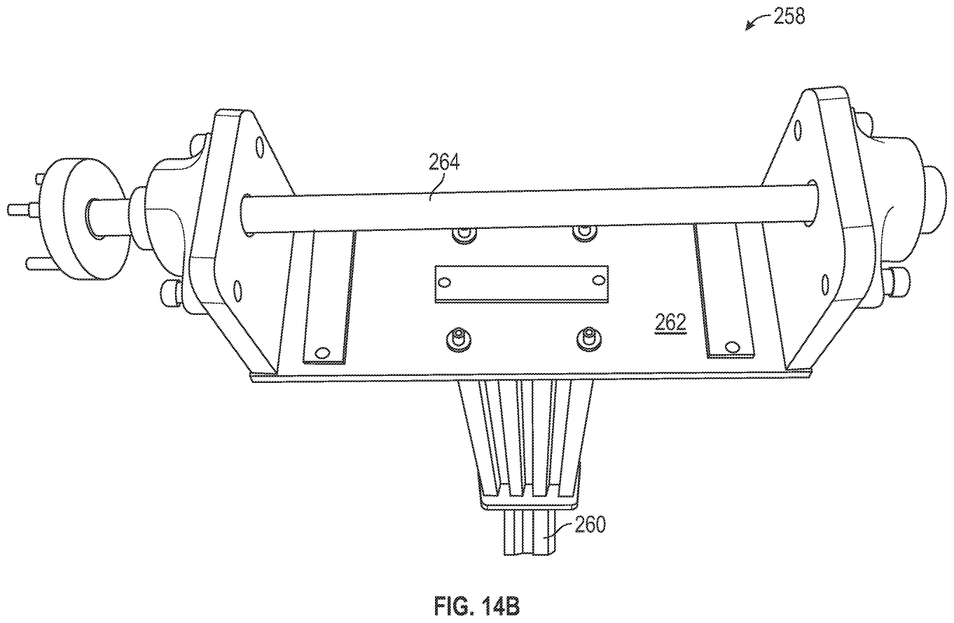

Referring now to FIGS. 14A-14B, the receiving members 58 at the testing module positions P4 and P8 may each be configured to receive a calibration module 258. The calibration module 258 may include a connection member 260 configured to be inserted into the receiving members 58 at the testing module position P4 for various efforts testing and into the receiving members 58 at the testing module position P8 for fold calibration testing. The calibration module 258 may extend upward from the connection member 260 to a bracket 262 having a bar 264 extending therethrough. When connected to the fixture 10 at testing module positions P4 or P8, the bracket 262 and bar 264 are disposed at a suitable height above the platform 18 to conduct calibration testing.

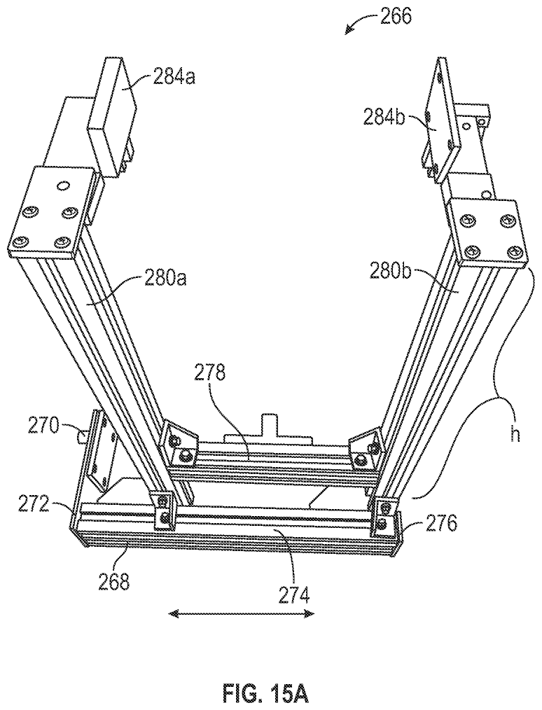

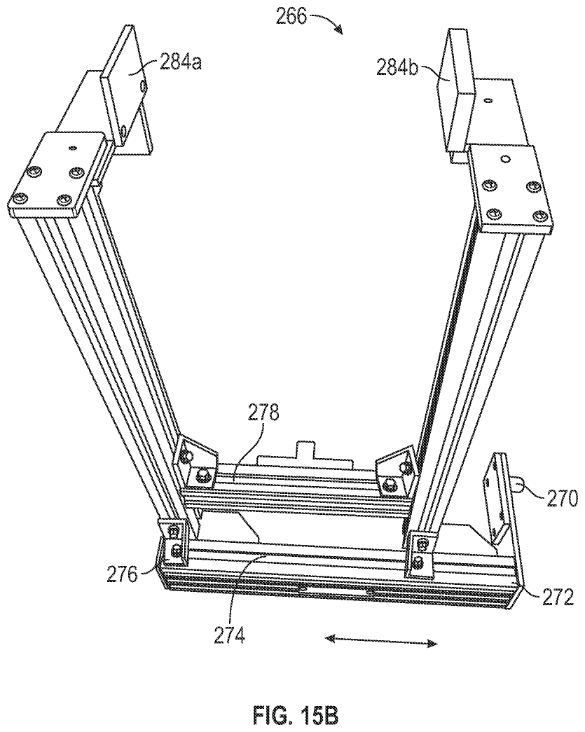

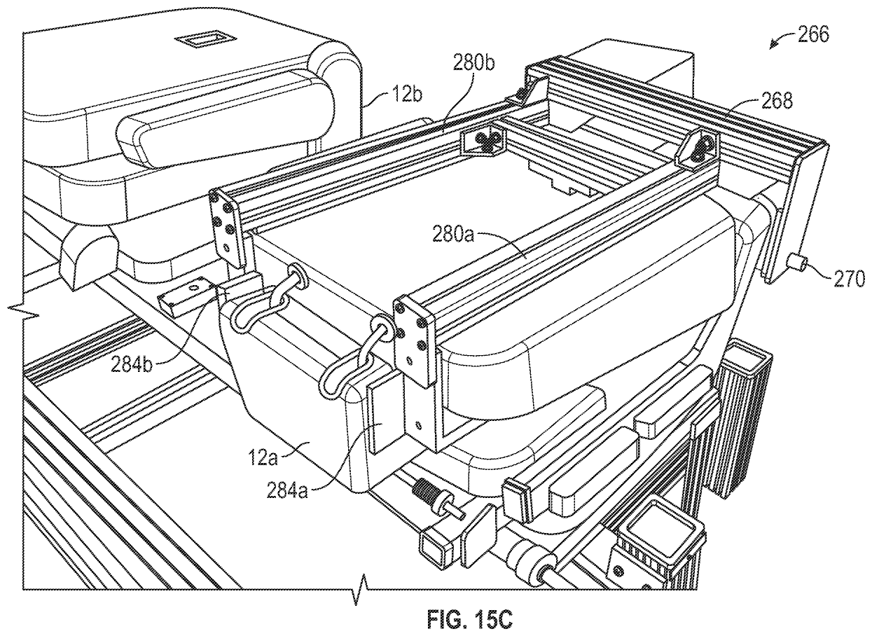

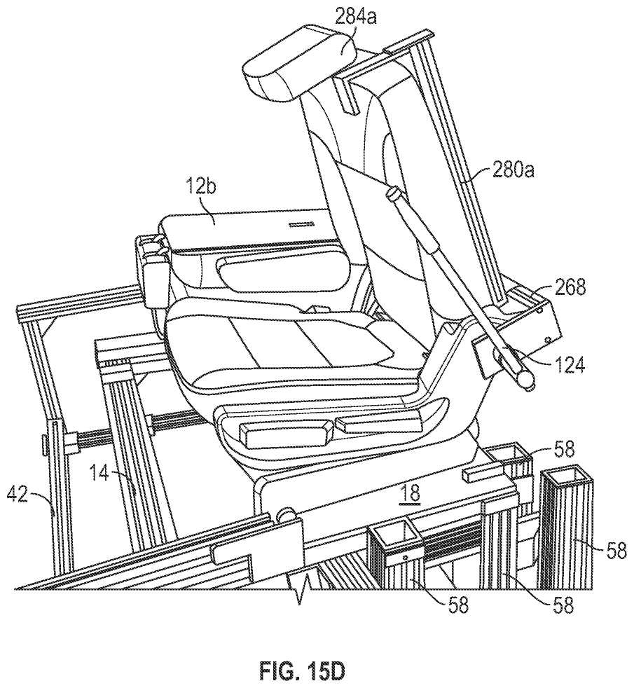

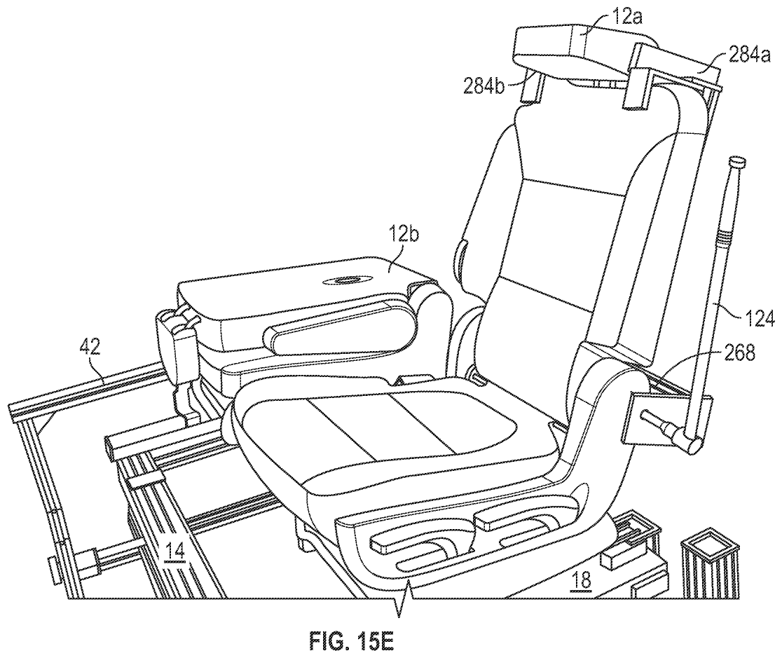

Referring now to FIGS. 15A-15E, the fixture 10 may include a seat back lift assembly 266 that may be converted from a LH mode for testing LH seat assemblies 12a to a RH mode for testing RH seat assemblies 12b. FIG. 15A shows the LH mode, and FIG. 15B shows the RH mode. The seat back lift assembly 266 may include a base 268 having a tumble return arm 270 on a first side 272 and a track 274 extending from the first side 272 to a second side 276. A clamping mechanism 278 can be slidably connected to the base 268 in the track 274, and able to slide across the base 268 from the first side 272 to the second side 276 as shown by the double sided arrows in FIGS. 15A-15B. The clamping mechanism 278 may include two arms 280a, 280b extending a desired height h to an endpoint 282 from which gripping members 284a, 284b extend. A first gripping member 284a and a second gripping member 284b are disposed a desired distance apart from each other, based on the dimensions of a seat assembly 12 to be tested. In use, as depicted in FIGS. 15C-15E, the seat back lift assembly 266 is configured to grip the top of the seat back 82 with the arms 280a, 280b extending along the rear 83 of the seat back 82. The tumble return arm 270 is disposed in a location where a user may attach a lever arm 124 and use the seat back lift assembly 266 to fold the seat assembly 12 down as seen in FIG. 15D and then measure the effort required to return the seat assembly 12 to the upright position as seen in FIGS. 15D-15E. The seat back lift assembly 266 does not need to be fixedly attached to the fixture 10.

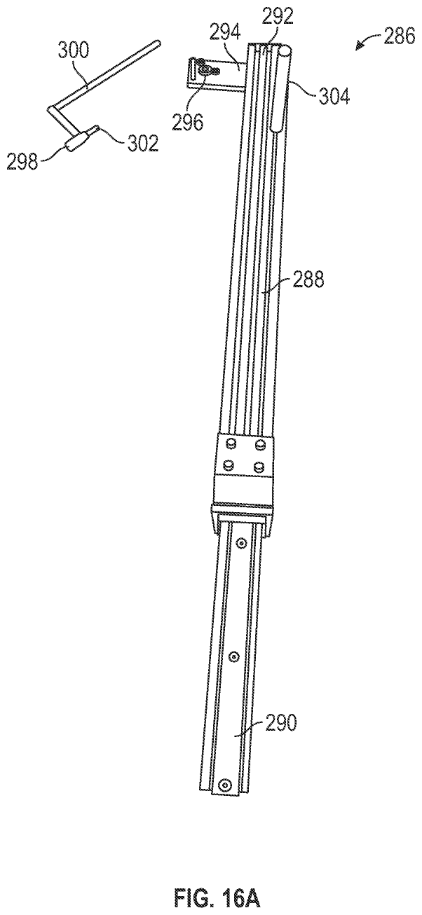

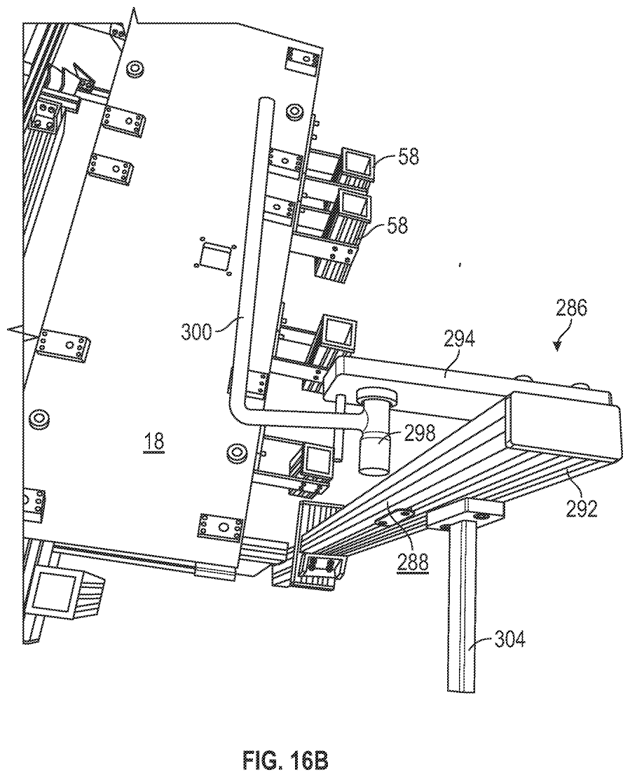

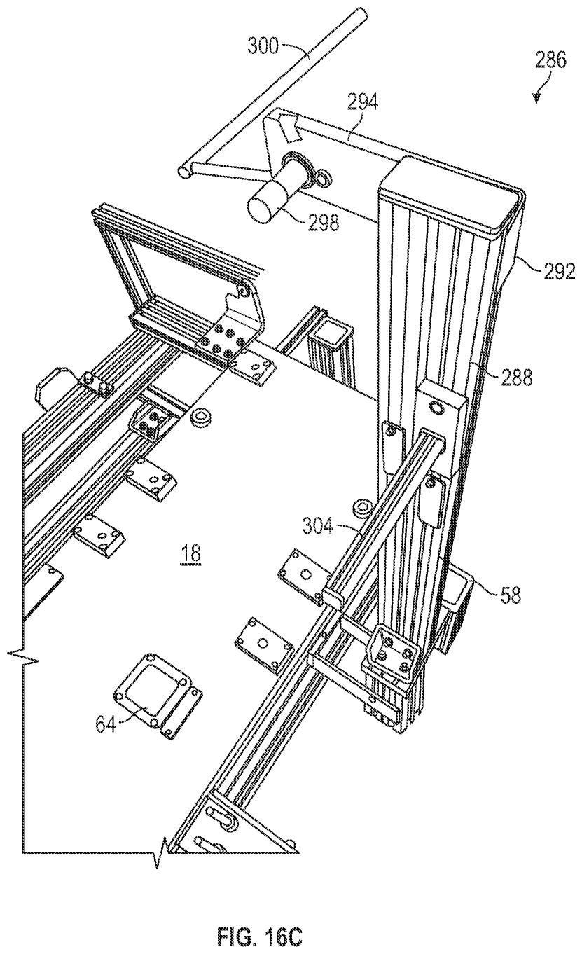

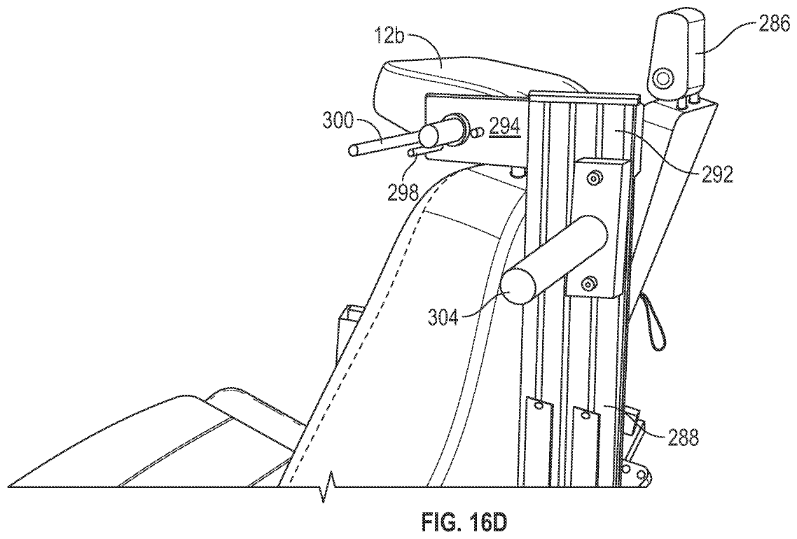

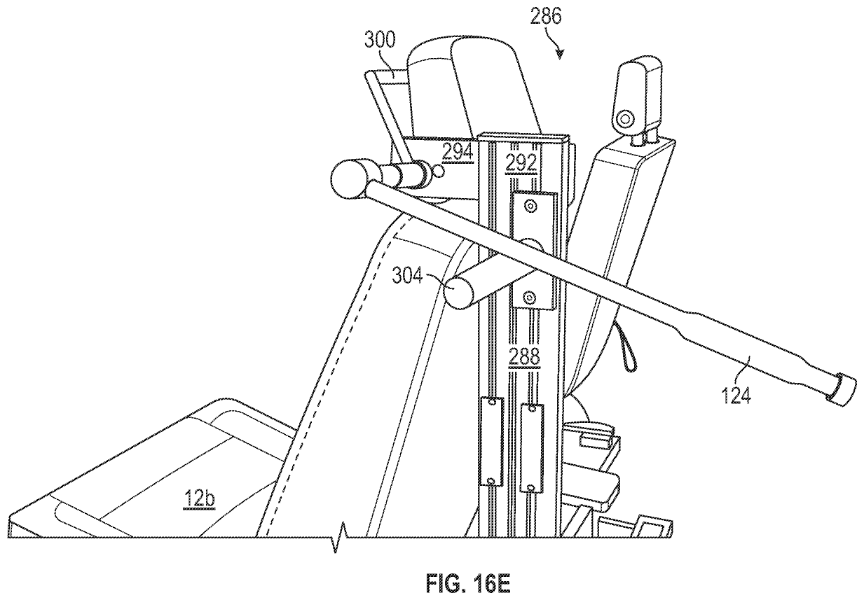

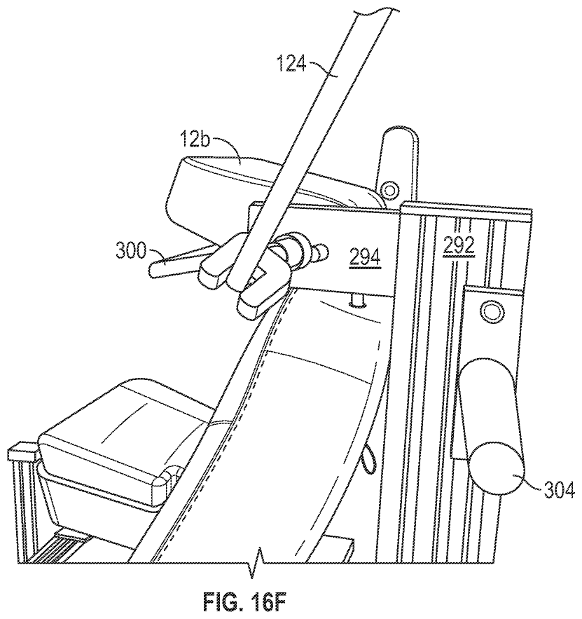

Referring now to FIGS. 16A-16F, the receiving members 58 at the testing module positions P2 and P6 may be configured to receive a headrest lift assembly 286. When present at testing module position P2, the headrest lift assembly 286 may be useful as LH headrest lift assembly, and when present at the testing module position P6, the headrest lift assembly 286 may be useful as RH headrest lift assembly. The headrest lift assembly 286 shown in FIG. 16A may be utilized in the same configuration as either a LH headrest lift assembly or a RH headrest lift assembly, determined by which testing module position the headrest lift assembly 286 is connected at.

The headrest lift assembly 286 may include an elongated member 288 extending a height from a connection member 290, configured to be inserted into a receiving member 58, to a top area 292. The top area 292 may be connected to a support arm 294 extending in a substantially orthogonal manner from the elongated member 288. The support arm 294 may include an aperture 296 therein configured to receive a rod 302. The headrest lift assembly 286 may further include a test arm 300 having a rod 302 and a handle 298 opposing the rod, where the rod 302 is configured to be inserted into the aperture 296 to connect the test arm 300 to the support arm 294. The headrest lift assembly 286 may further include a handle 298 extending from the elongated member 288. In use, the test arm 300 may be rotated around an axis defined by the rod 302 by rotating the handle 298 opposing the rod 302.

As shown in FIGS. 16D-16F, the test arm can 300 be connected by inserting the rod 302 on the test arm 300 into the aperture 296 on the support arm 294. A tilt test may be performed by rotating the test arm 300 by rotating the rod 302 within the aperture 296 with a suitable torqueing device such as a lever arm 124. The torqueing device may be stopped by a stop arm 304 extending from the elongated member 288. The efforts involved may be measured with a suitable gauge 56. FIGS. 16D-16F illustrate this with respect to a LH seat assembly 12a, but the same procedure can be performed with respect to a RH seat assembly 12b. Thus, the headrest lift assembly 286 may be utilized to perform checks of a headrest 86 on a seat assembly 12.

As noted above, the outer rail assembly 42 is pivotably attached to the carriage 14 through joints 52a, 52b. Referring now to FIGS. 17A-17B, the outer rail assembly 42 may pivot between a first (or down) position and a second (or up) position. Furthermore, the outer rail assembly 42 may include one or more connection plates 306 comprising mounting apertures 308. The connection plates 306 are configured to mount a testing gauge 56 or other equipment useful for measuring efforts.

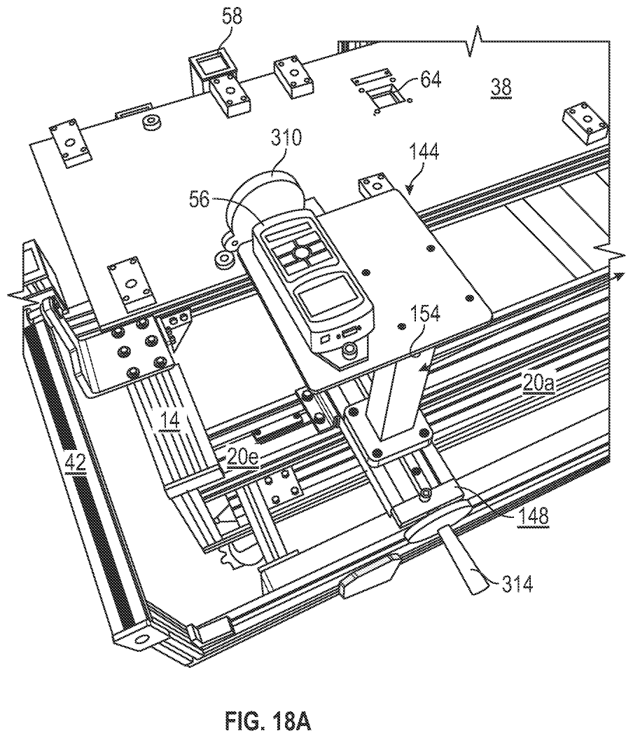

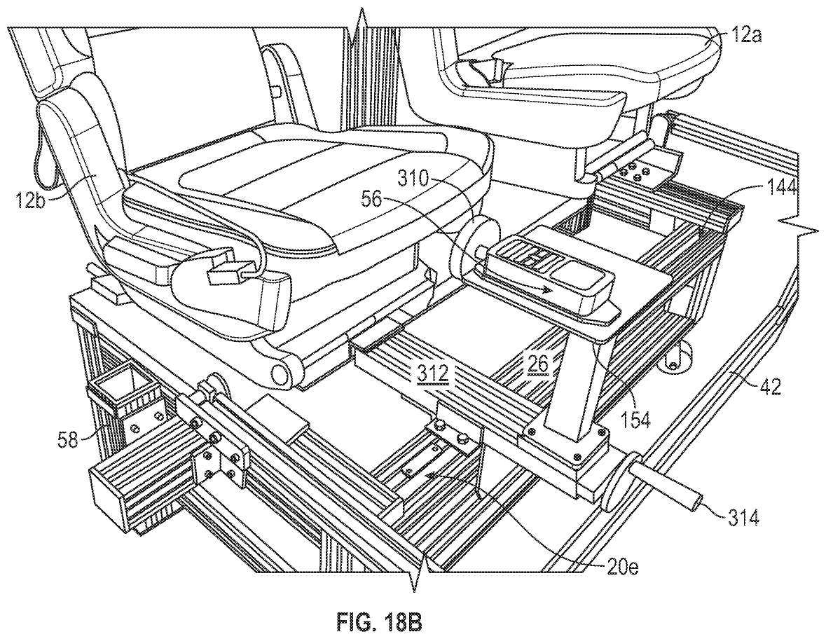

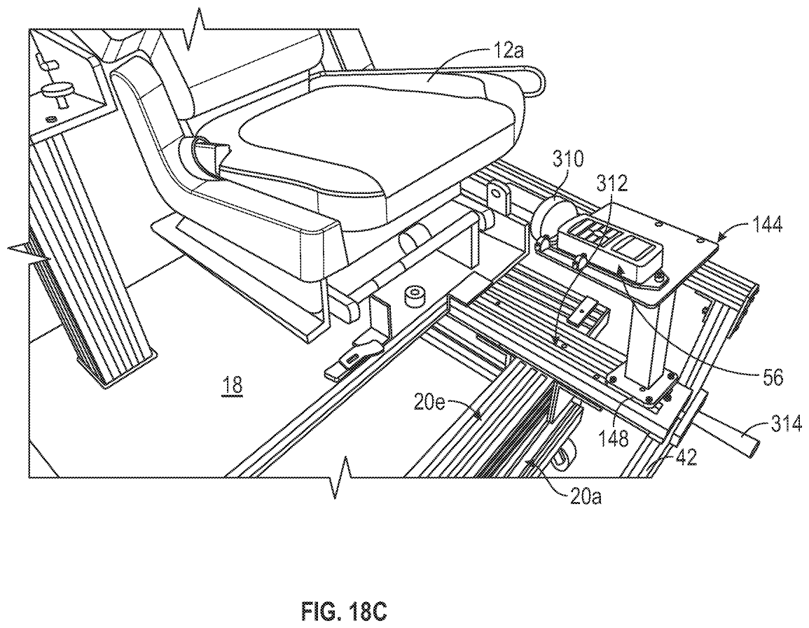

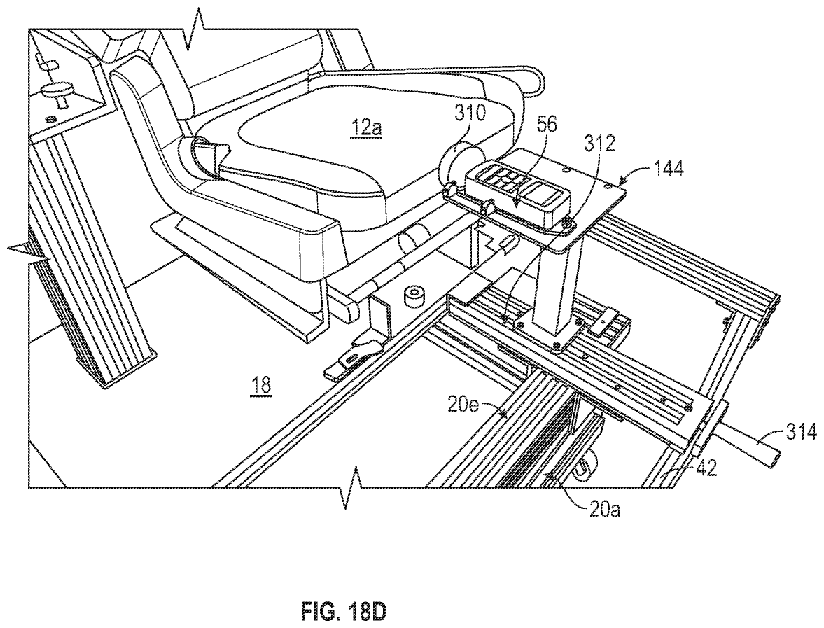

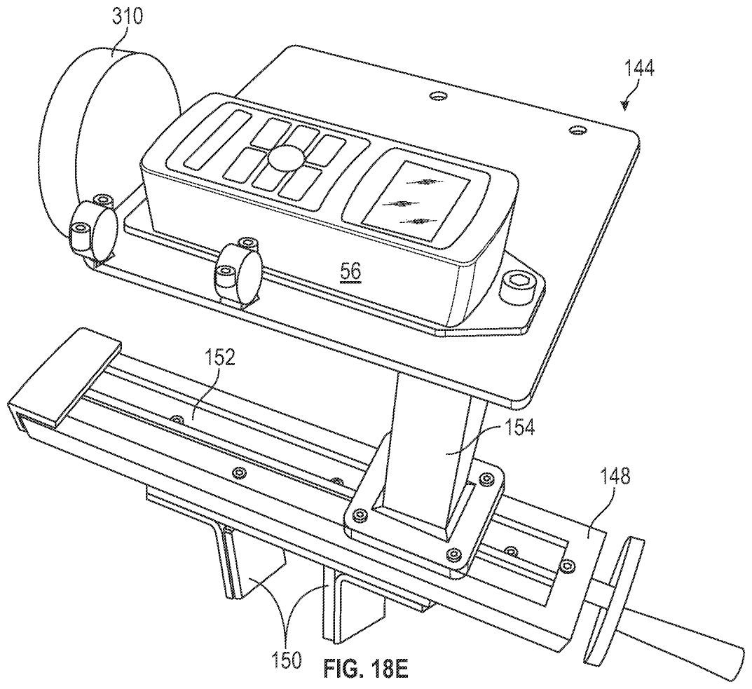

As noted above, the carriage 14 may include a rearward track 26 on a top surface 28 of the second front longitudinal member 20e. Referring now to FIGS. 18A-18C, the slide member 144 described above may be slidably mounted on the rearward track 26 and may provide a slidable platform on which a force or torque gauge 56, or other equipment useful for measuring efforts, may be disposed. The track member 148 of the slide member 144 may be slidably mounted on the rearward track 26, with the elevated platform 154 slidably mounted on the track member 148, thus allowing for the elevated platform 154 to move in directions from the LH side 30 to the RH side 32 or in directions from the rear side 34 to the front side 36, as indicated by the double sided arrows in FIGS. 18A-18B. FIG. 18B depicts a meter 56 with a round puck 310 attached thereto. The elevated platform 154 can be locked into place within the track member 148 with a suitable locking mechanism such as a plastic stopper 312. A track release handle 314 may be utilized to slide the elevated platform 154 within the track member 148. The slide member 144 may be moved between S1 and S2 to perform tests on a RH seat assembly 12b or LH seat assembly 12a, respectively.

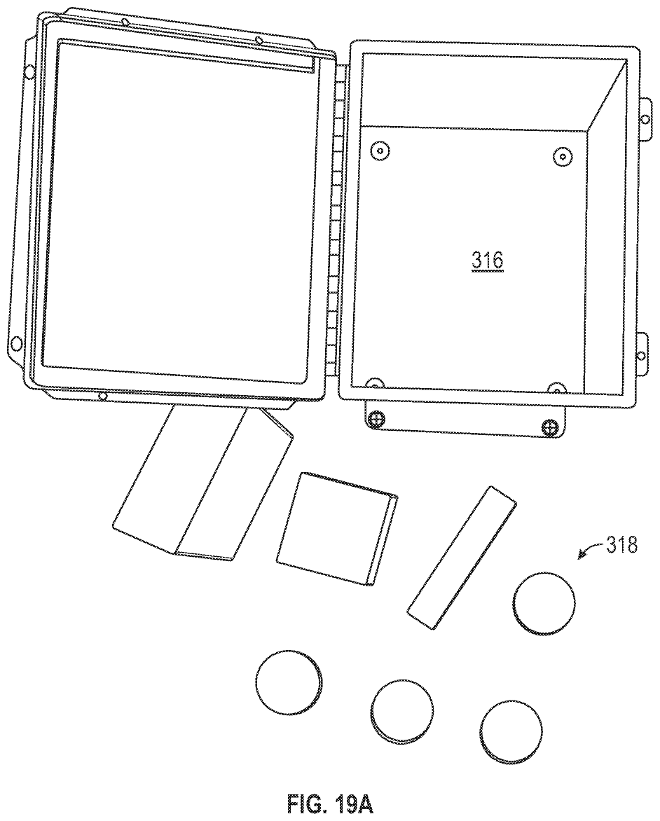

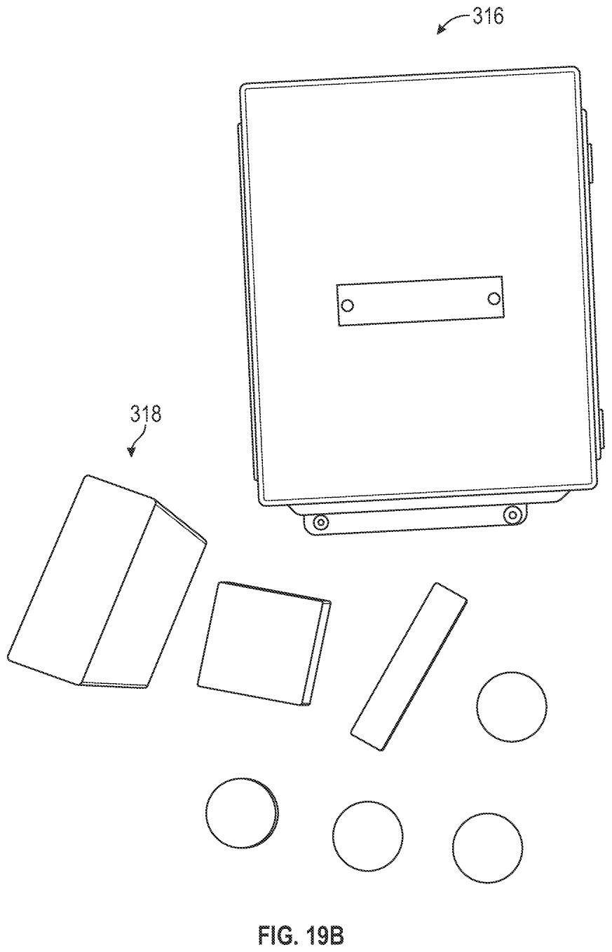

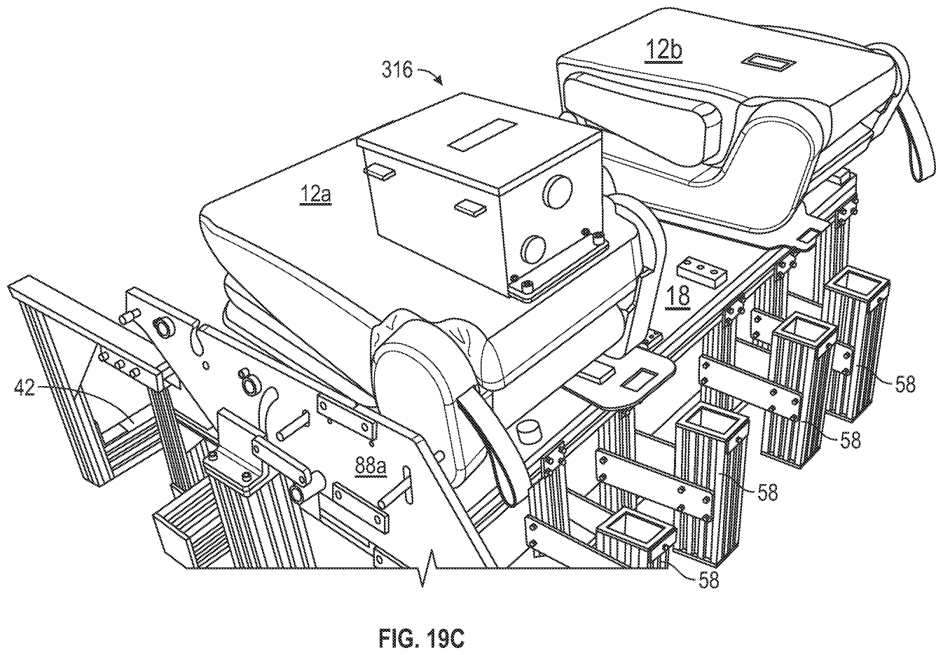

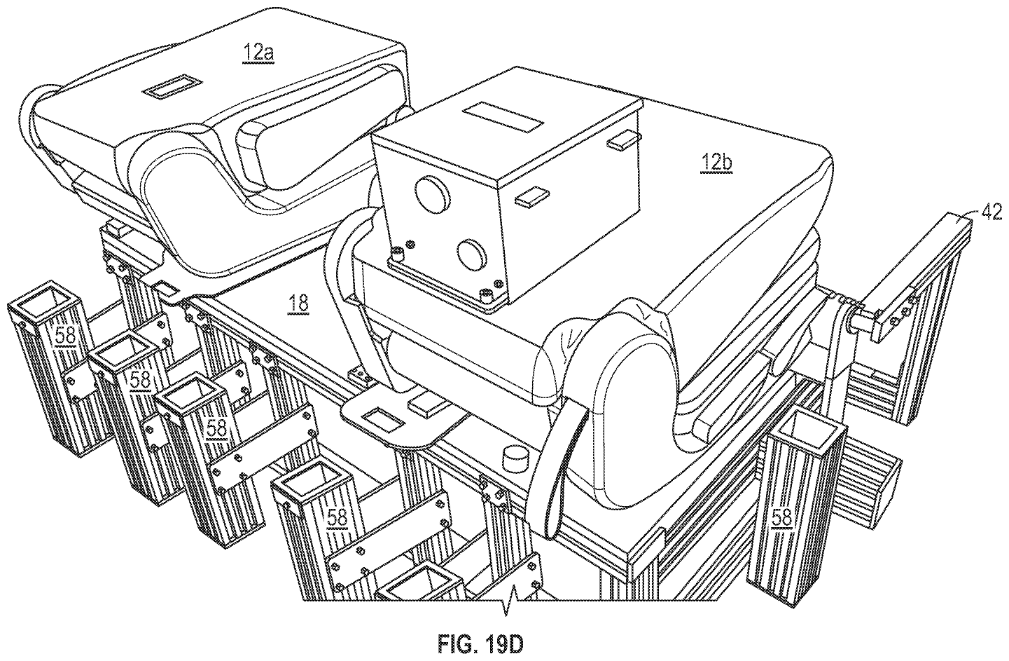

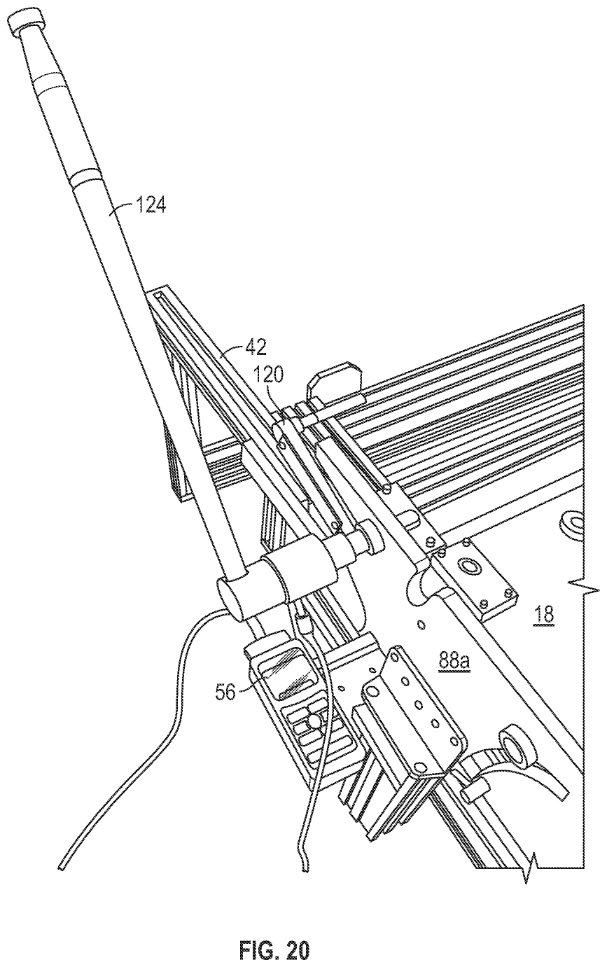

Referring now to FIGS. 19A-19D, a weight box 316 and weights 318 may be provided with the fixture 10 to accommodate certain efforts testing, as described in more detail below. The weight box 316 may be any suitable box capable of holding the desired amount of weight. The weight box 316 may be useful in testing how much force is needed to secure a seat assembly 12 in a desired folded position, such as when the hooks are placed into the iso bar. The weight box 316 may be placed onto the seatback 82 when in the folded position, as seen in FIGS. 19C-19D. Weights 318 may be added into the weight box 316 until the seat clips in, and the amount of weight needed to accomplish this may be recorded.

Advantageously, the fixture 10 allows for a complete check of one or more seat assemblies 12 in an efficient and reliable manner, and without the need for a dummy or manikin to sit in the seat assembly 12 during testing. The fixture 10 is adjustable to accommodate any seat configuration, and therefore may be utilized with any vehicle seat assembly 12.

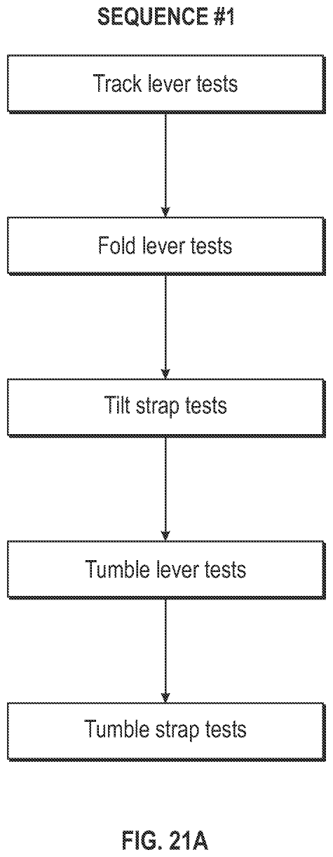

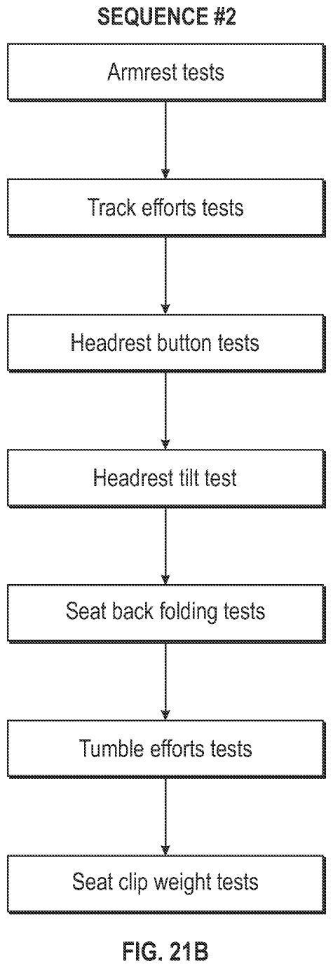

Further provided herein are methods of using the fixture 10 to check the efforts of a seat assembly 12. FIG. 21A illustrates an example first sequence, and FIG. 21B illustrates an example second sequence of a non-limiting example method for checking the efforts of two seat assemblies (namely, a RH seat assembly and a LH seat assembly). When combined, the first sequence and the second sequence allow for complete seat tests in an efficient and reliable manner. In a first test sequence, the following tests may be performed: track lever tests, fold lever tests, tilt strap tests, tumble lever tests, and tumble strap tests. In a second test sequence, the following tests may be performed: armrest tests, track efforts tests, headrest button tests, headrest tilt tests, seat back folding tests, tumble efforts tests, seat clip weight tests. The test sequences may be undertaken in any particular order. However, this order in particular may result in the most efficient complete effort check.

In the first sequence, the LH lever test module 88a is inserted into the receiving member 58 at the testing module position P1 as depicted in FIG. 5C, then the anti-tilt tooling assembly 186 is inserted into the receiving member 58 at the testing module position P4 as depicted in FIGS. 11A-11C, and both seats 80a, 80b are tilted forward as depicted in FIG. 11D. Then, the LH strap pull assembly 162a is inserted into the receiving member 58 at the testing module position P3 as depicted in FIG. 9B, and the RH strap pull assembly 162b is inserted into the receiving member 58 at the testing module position P6 as depicted in FIG. 10D. Then, both seats 80a, 80b are tilted back into the first locked position. Then, the LH lever test may be performed by actuating the arm 120 disposed in the tilt lever aperture 104a of the LH lever test module 88a as seen in FIGS. 5D-5E and the arm 120 disposed in the fold lever aperture 106a as seen in FIGS. 5F-5G. The long stop 122a is inserted into the forward stopping aperture 126a to stop the rotation of the arm 120 while rotating in the tilt lever aperture 104a, and the long stop 122a is inserted onto one of the handles 96a to act to stop the rotation of the arm while rotating in the fold lever aperture 106a.

After the LH lever test, the fold strap test LH may be performed as depicted in FIGS. 9D-9E, and then the fold strap test RH may be performed in a similar manner as depicted in FIGS. 10D-10E, utilizing the strap pull assemblies 162a, 162b to pull the straps 76a, 76b as described above. The lever test module 88 is then moved from testing module position P1 to testing module position P7, as seen in FIG. 6B, thereby becoming the RH lever test module 88b. Then, the RH lever test is performed by actuating the arm 120 disposed in the tilt lever aperture 104b of the RH lever test module 88b and the arm 120 disposed in the tumble lever module 106b of the RH lever test module 88b. Then, the anti-tilt tooling assembly 186 is removed from testing module position P4 and put away, as seen in FIG. 7A, and the seats 80a, 80b are put into the folded position, as seen in FIG. 7B. The RH lever test is then performed with the tumble handle 74b as seen in FIG. 6C. Specifically, an arm 120 is inserted into the tumble aperture 130b of the RH lever test module 88b, where the arm 120 fits into the curved slot 110b of the RH lever test module 88b. Then, the arm 120 is rotated with a suitable torqueing tool such as a lever arm 124 within the confines allowed by the curved slot 110b. Then, a tumble strap test RH is performed, and a tumble strap test LH is performed, using the respective lever test module 88 to pull a tumble strap of the seat assemblies 12a, 12b. Then, the lever test module 88 is moved from testing module position P7 to testing module position P1, thereby becoming the LH lever test module 88a again, and the LH lever test is performed with an arm 120 in the tumble aperture 130a in the same manner as described above with respect to the RH lever test. Finally, the lever test module 88 and LH/RH strap pull assemblies 162a, 162b are removed and put away, and the first sequence is completed.

In the second sequence, the captain arm rest test assembly 230 is inserted into the receiving member 58 at the testing module position P8, and the test is performed on the LH arm rest 84a as depicted in FIGS. 13D-13F, and then the RH arm rest 84b.

Then, the slide member 144 is put onto rearward track 26 at the front side 36 of the fixture 10 and pushed into the S1 position as seen in FIGS. 18A-18B. A hook is put onto the track release handle 314 LH/RH side. A round puck 310 is put on the front of the test meter 54. A plastic stopper 312 is inserted into the track member 148 for the track test, and the test of track efforts is performed. Then, the slide member 144 is pushed into the S2 position as depicted in FIG. 18C, and a test of track efforts is performed as depicted in FIG. 18D.

Then, the LH headrest button test assembly 132 is inserted into the receiving member 58 at the testing module position P2, as seen for example in FIG. 8D. The seat 80 may be tilted slightly to accommodate this. The slide member 144 is moved to the S3 position located on the beam 138, as seen in FIG. 8A. FIG. 4 depicts the slide position S3 as being near the testing module positions P2 and P5, but it is understood that S3 may move with the location of the beam 138. The round puck 310 on the meter 56 is changed to a bullet nose pin 160, as seen in FIGS. 8A-8B. The plastic stopper 312 is removed from the track member 148 and replaced with a headrest support 156 as seen in FIGS. 8A-8B. The LH headrest button test is performed as shown in FIG. 8E.

After the LH headrest button test is performed, the button test assembly 132 is moved from testing module position P2 to testing module position P6 as seen in FIG. 8F, and the RH headrest button test is then performed as seen in FIG. 8G. Then, the headrest button assembly 132 is removed and put away. The button 87 is pushed and both headrests 86a, 86b are pushed down. The seat assemblies 12a, 12b may need to be tilted forward to fit the headrest lift assembly 286 into position. The headrest lift assembly 286 is inserted into the receiving member 58 at the testing module position P2 as shown in FIG. 16D, and the LH headrest tilt test is performed by lifting the headrest 86 out of its tilted position with the test arm 300, as seen in FIGS. 16E-16F. Then, the headrest lift assembly 286 is moved from testing module position P2 to testing module position P6, and the RH headrest tilt test is performed in the same manner. Then, the headrest tilt assembly 286 is removed and put away.

The captain armrest test assembly 230 is put away, and the efforts gauge 56 is moved from the slide member 144 (with 2 bolts) and installed onto the tumble return arm 270 of the seat back lift assembly 266 on the LH side 30. This involves changing the bullet nose pin 160 back to a round puck 310 and inserting a tumble stop 320 into the receiving member 58 at the testing module position P7. The LH seat 80a is then tumbled as shown in FIG. 15C, and the LH tumble return test is performed as shown in FIGS. 15D-15E by measuring the effort needed to return the LH seat 80a to the upright position with the lever arm 124. Then, the efforts gauge 56 is moved to the RH side of the tumble return arm 270, and the RH tumble return test is performed in the same manner.

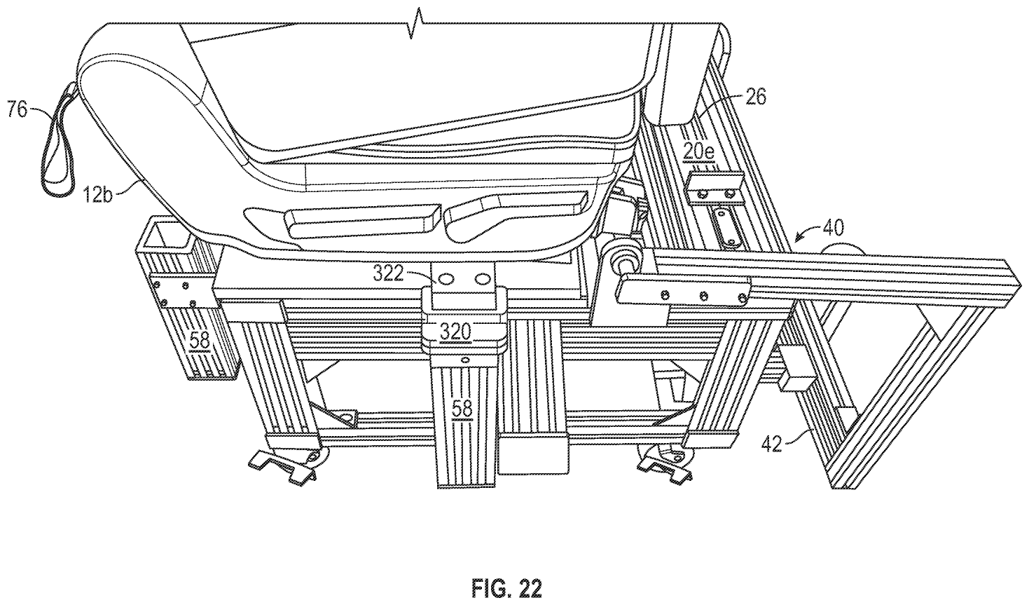

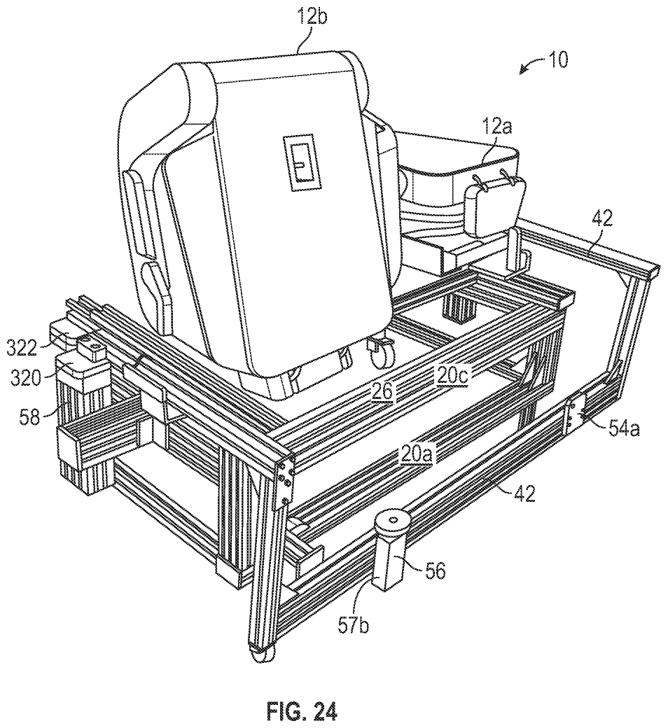

To prepare for a tumble return test, all the previously used testing modules attached to the fixture 10 may be put away. The seat assembly 12 may be folded and tumbled. The seat back 82 is not clipped into the folded position to conduct the tumble return test. The bullet nose pin 160 is removed from the efforts gauge 56 and the round puck 310 is put back on. Then, the efforts gauge 56 is taken off of the slide member 144 with 2 bolts. Referring now to FIG. 22, a tumble stop 320 is inserted into the receiving member 58 at the testing module position P7. The tumble stop 320 includes a stopping member 322 protruding from the receiving member 58 at the testing module position P7. Then, an efforts gauge 56 is placed onto the bracket 54a on the outer rail assembly 42 on the LH side 30 as shown in FIG. 23. The seat 80a is then tumbled with the test gauge 56 on the fixture 10, as shown in FIG. 24. The tumble return test is then performed as depicted in FIG. 25 by measuring the effort needed to return the tumbled seat 80 to the desired folded position. As seen in FIG. 25, the pivoting motion of the outer rail assembly 42 is stopped at the desired position by the tumble stop 320 at the testing module position P7, which comes into contact with a top surface 53 of the joint 52a. The round puck 310 on the effort gauge 56 mounted on the outer rail assembly 42 measures the effort during the tumble return test. The tumble return test is then repeated on the RH seat assembly 12b. Once completed, the tumble return assembly 40 is returned to the down position and the tumble stop is removed from the receiving member 58 at the testing module position P7.

A weight box 316 is then put onto the LH seat 80a, as depicted in FIG. 19C, weights 316 are added until the seat 80a hooks into place, and the amount of weight need to accomplish this is recorded. Then, a weight box 316 is put onto the RH seat 80b as depicted in FIG. 19D, weights 316 are added until the seat 80b hooks into place, and the amount of weight needed to accomplish this is recorded. The tumble hooks should be fully down for these tests. Finally, a return from fold test is performed on the RH seat 80b and then LH seat 80a using the seatback lift assembly 266, making sure the hook is secured into the iso bar. Following this, the seat tests are complete.

Certain embodiments of the fixtures, assemblies, and methods disclosed herein are defined in the above examples. It should be understood that these examples, while indicating particular embodiments of the invention, are given by way of illustration only. From the above discussion and these examples, one skilled in the art can ascertain the essential characteristics of this disclosure, and without departing from the spirit and scope thereof, can make various changes and modifications to adapt the fixtures, assemblies, and methods described herein to various usages and conditions. Various changes may be made and equivalents may be substituted for elements thereof without departing from the essential scope of the disclosure. In addition, many modifications may be made to adapt a particular situation or material to the teachings of the disclosure without departing from the essential scope thereof.

What is claimed is:

1. A fixture comprising:
a carriage and a platform mounted on the carriage, wherein the platform is configured to receive one or more seat assemblies and the carriage comprises an assembly of members forming a base; and
a plurality of receiving members located at testing module positions around or in the platform, wherein each of the plurality of receiving members defines an opening and is either fixedly attached to the carriage at a distance away from the carriage or defines a platform opening.

2. The fixture of claim 1, further comprising a tumble return assembly having an outer rail extending between positions outwardly displaced from the base, wherein the tumble return assembly is pivotably attached to the carriage and movable from a first position to a second position.

3. The fixture of claim 2, wherein the outer rail comprises at least one mounting bracket.

4. The fixture of claim 1, comprising a lever test module connected to one of the plurality of receiving members on a left-hand side or right-hand side of the fixture, wherein the lever test module comprises a connection member attached to connected plates having a plurality of apertures and handles therein, the lever test module comprising a curved slot and a straight slot extending from an edge of the lever test module.

5. The fixture of claim 4, further comprising a long stop inserted onto one of the handles on the connected plates.

6. The fixture of claim 1, further comprising a headrest button test assembly connected to one of the plurality of receiving members on a rear side of the fixture, the headrest button test assembly comprising a connection member and a beam extending in a substantially orthogonal manner relative to the connection member, wherein the beam includes upstanding arms on a top surface thereof.

7. The fixture of claim 6, further comprising a slide member mounted on the beam, wherein the slide member comprises an elevated platform slidably connected to a track member, and the track member is mounted on the beam.

8. The fixture of claim 1, further comprising a strap pull assembly connected to the fixture through one of the plurality of receiving members, wherein the strap pull assembly includes a connection member inserted into the one of the plurality of receiving members, a bracket mounted on the connection member, and a first beam and a second beam fixedly attached to the bracket, wherein the first beam comprises a first long stop extending therefrom and the second beam comprises a second long stop extending therefrom, and the bracket assembly further comprises a plate having a bushing therein.

9. The fixture of claim 8, further comprising an arm rotatably connected to the plate at the bushing, wherein the arm comprises a handle extending therefrom.

10. The fixture of claim 1, further comprising an anti-tilt tooling assembly connected to the fixture through one of the plurality of receiving members, wherein the anti-tilt tooling assembly comprises a connection member inserted into the one of the plurality of receiving members, an elongated shaft extending from the connection member to a bridging member that extends in a substantially orthogonal direction relative to the elongated shaft, the bridging member extending to a cross member that extends in a substantially orthogonal manner relative to the bridging member, and the anti-tilt tooling further comprises at least one stopper mounted from a first side of the cross member.

11. The fixture of claim 10, wherein the at least one stopper extends an adjustable distance from the cross member.

12. The fixture of claim 10, wherein the anti-tilt tooling comprises a second stopper mounted from a second side of the cross member.

13. The fixture of claim 1, further comprising an armrest bench seat test assembly connected to the fixture at one of the plurality of receiving members, the armrest bench seat test assembly comprising a connection member inserted into the one of the plurality of receiving members, an elongated shaft extending from the connection member, a mounting arm comprising an aperture therein, and an attachment comprising two prongs, wherein the attachment is rotatably attached to the mounting arm at the aperture.

14. The fixture of claim 1, further comprising a captain armrest test assembly connected to the fixture at one of the plurality of receiving members, wherein the captain armrest test assembly comprises a connection member inserted into the one of the plurality of receiving members, an elongated member extending from the connection member, and a bracket on the elongated member, wherein the bracket comprises a first aperture on a first side and a second aperture on an opposing second side.

15. The fixture of claim 14, further comprising a test arm having two prongs, wherein the test arm is rotatably attached to the bracket at either the first aperture or the second aperture.

16. The fixture of claim 15, further comprising a stop handle on the elongated member above the bracket relative to the platform.

17. The fixture of claim 1, further comprising a calibration module connected to one of the plurality of receiving members, wherein the calibration module comprises a connection member inserted into the one of the plurality of receiving members, a bracket supported above the connection member, and a bar extending through the bracket.

18. The fixture of claim 1, further comprising a seat back lift assembly having a base with a handle on a first side and a track extending from the first side to a second side, wherein a clamping mechanism is slidably connected to the base in the track, the clamping mechanism comprising two arms extending to an endpoint, wherein gripping members extend from the endpoint, and wherein the seat back lift assembly is mounted on a seat assembly connected to the fixture.

19. The fixture of claim 1, further comprising a headrest lift assembly connected to one of the plurality of receiving members, wherein the headrest lift assembly comprises a connection member inserted into the one of the plurality of receiving members, an elongated member extending from the connection member to a top area, and a support arm extending from the top area, wherein the support arm comprises an aperture therein.

20. The fixture of claim 19, further comprising a prong member having a prong rotatably connected to the support arm at the aperture.

21. The fixture of claim 1, further comprising a slide member mounted on a rearward track defined by a top surface of one of the assembly of members, wherein the slide member comprises an elevated platform slidably connected to a track member, and the track member is slidably mounted on the rearward track.

22. The fixture of claim 1, further comprising a weight box disposed on a folded seat assembly, wherein the folded seat assembly is attached to the fixture on the platform.

23. The fixture of claim 1, wherein the carriage further comprises wheels configured to allow movement of the fixture.

24. The fixture of claim 1, further comprising a tumble stop inserted into one of the plurality of receiving members, the tumble stop comprising a stopping member protruding from the one of the plurality of receiving members.

25. A method for effort testing vehicle seat assemblies, the method comprising:
attaching a first seat assembly and a second seat assembly to a fixture, wherein the fixture comprises a carriage, a platform mounted on the carriage, and a plurality of receiving members located around or in the platform, wherein the receiving members are configured to receive testing modules;
conducting a first sequence of tests on the first seat assembly and the second seat assembly with testing modules in the receiving members, wherein the first sequence of tests comprises track lever tests, fold lever tests, tilt strap tests, tumble lever tests, and tumble strap tests; and
conducting a second sequence of tests on the first seat assembly and the second seat assembly with testing modules in the receiving members, wherein the second sequence of tests comprises armrest tests, track effort tests, headrest button tests, headrest tilt tests, seat back folding tests, tumble efforts tests, and seat clip weight tests.
